(19) United States
(12) Patent Application Publication
(10) Pub. No.: US 2017/0178266 A1
(43) Pub. Date: Jun. 22, 2017

(54) INTERACTIVE DATA VISUALISATION OF VOLUME DATASETS WITH INTEGRATED ANNOTATION AND COLLABORATION FUNCTIONALITY

(71) Applicant: SAP SE, Walldorf (DE)

(72) Inventor: Olaf Schmidt, Walldorf (DE)

(21) Appl. No.: 14/971,712

(22) Filed: Dec. 16, 2015

(51) Int. Cl. G06Q 50/22; G06F 17/22; G06F 17/24; H04L 29/06; G06F 3/0481

(52) U.S. Cl. CPC G06Q 50/22; H04L 63/10; G06F 3/04815; G06F 17/241; G06F 17/2235

(57) ABSTRACT

Opening an accessed electronic medical record (EMR) on a mobile computing device. Receiving a rendered visualization of a three-dimensional (3D) volume dataset associated with the EMR in a graphical user interface (GUI) on the mobile device. The visualization can be interacted with using the GUI. A bookmark associated with the rendered visualization and an annotation associated with the rendered visualization and the defined bookmark can be defined.

### CLAIM OF PRIORITY

This application is related to U.S. patent application Ser. No. 14/305,647, filed on Jun. 16, 2014; the entire contents of which are hereby incorporated by reference.

### BACKGROUND

In scientific visualization and computer graphics, volume rendering is a set of techniques used to display a two-dimensional (2D) projection of a three-dimensional (3D) discretely sampled dataset. A typical 3D dataset is a group of 2D “slice” images acquired by tools such as an X-ray computer tomography (CT), magnetic resonance imaging (MM), a Micro-CT scanner, and/or other tools. 3D datasets can also be generated by software systems such as those used to design, model, and analyze buildings, machines (e.g., automobiles, aircraft, watercraft, etc.), DNA and other molecular structures (e.g., genetic diseases, medications, etc.), oil & gas exploration, financial analysis, and the like.

Current systems for volume rendering utilize specialized graphics hardware to process the huge amount of data produced by scanners. Typically, an end-user needs access to specialized, expensive, high-end workstations in order to work with and/or volume render the scanned datasets; therefore limiting the use of 3D volume renderings to specialists and particular groups of researchers. This has the effect of dampening the utilization of highly relevant, useful, and/or valuable 3D renderings, for example in medical diagnostics (e.g., cancer detection, neurological studies, research, etc.), engineering, education, and the like. Additionally, these volume rendering systems do not provide interactive, real-time visualization of volume renderings that include integrated annotation and collaboration functionality.

### SUMMARY

The present disclosure relates to computer-implemented methods, computer-readable media, and computer systems for real-time interactive data visualisation of three-dimensional (3D) volume datasets with integrated annotation and collaboration functionality.

Opening an accessed electronic medical record (EMR) on a mobile computing device. Receiving a rendered visualization of a 3D volume dataset associated with the EMR in a graphical user interface (GUI) on the mobile device. The visualization can be interacted with using the GUI. A bookmark associated with the rendered visualization and an annotation associated with the rendered visualization and the defined bookmark can be defined.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

One computer-implemented method includes opening an accessed EMR on a mobile computing device; receiving, in a GUI on the mobile device, a rendered visualization of a 3D volume dataset associated with the EMR; interacting with the visualization using the GUI; defining a bookmark associated with the rendered visualization; and defining an annotation associated with the rendered visualization and the defined bookmark..

The foregoing and other implementations can each optionally include one or more of the following features, alone or in combination:

A first aspect, combinable with the general implementation, wherein the interactions include one or more of moving a viewing position, modifying a viewing direction, rotating a model, and zooming of a model.

A second aspect, combinable with any of the previous aspects, wherein the defined bookmark is stored in a bookmark persistence, the defined annotation is stored in an annotation persistence, and wherein defining the bookmark comprises: linking bookmark metadata to current rendering parameters; and defining groups of users with different access privileges who have access to the defined bookmark and can perform operations associated with the bookmark.

A third aspect, combinable with any of the previous aspects, comprising: modifying the defined bookmark, wherein modifying the defined bookmark comprises: generating a new bookmark version with modified rendering parameters; linking the new bookmark version metadata to current rending parameters; and defining access privileges to the new bookmark version for different users; and storing the modified bookmark into the bookmark persistence.

A fourth aspect, combinable with any of the previous aspects, comprising opening the rendering of the 3D volume dataset using the defined bookmark, the opening of the rendering of the 3D volume dataset comprises: checking access rights to open the bookmark; generating a visualization based on the rendering parameters associated with the bookmark; and retrieving annotations linked to the bookmark.

A fifth aspect, combinable with any of the previous aspects, comprising, following the opening of the EMR, starting a collaboration session associated with the 3D volume dataset of the EMR using a collaboration component and inviting other users to join the collaboration session.

A sixth aspect, combinable with any of the previous aspects, comprising recording the collaborative session and persisting session content using an associated session identification corresponding to the EMR.

A seventh aspect, combinable with any of the previous aspects, comprising: receiving a modified or new version of a bookmark; sharing the modified or new version of the bookmark with other collaboration session users; and creating one or more annotations associated with the modified or new version of the bookmark.

An eighth aspect, combinable with any of the previous aspects comprising sharing a previously-defined bookmark with a different user of the collaboration session.

A ninth aspect, combinable with any of the previous aspects, wherein the rendered visualization is associated with the shared, different, previously-defined bookmark.

Although the following described advantages are focused on medical scanning/datasets and the use of an in-memory database, the described computer-implemented methods, computer-program products, and systems are also applicable to other types of 3D volume rendering (e.g., design, modeling, and analysis of buildings, machines (e.g., automobiles, aircraft, watercraft, etc.), DNA and other molecular structures (e.g., genetic diseases, medications, etc.), oil & gas exploration, financial analysis, and the like) as well as the use of a conventional database (although performance would be degraded due to the operation of the conventional database). The focus of the disclosure on medical datasets is to enhance understanding of the described subject matter and is not meant to limit the applicability of the described subject matter only to medical datasets and particularly those datasets described. Applicability to other types of datasets consistent with this disclosure is considered to be within the scope of this disclosure, particularly where integration/combination of data from generated images and human annotations are useful for the purposes of interactive discussions.

The subject matter described in this specification can be implemented in particular implementations so as to realize one or more of the following advantages:

Three-Dimensional Volume Rendering Using an In-Memory Database

The subject matter described in this specification can be implemented in particular implementations so as to realize one or more of the following advantages. First, specialized graphics hardware/software is not necessary to perform 3D volume renderings. The data and renderings are available to a wider audience to enhance and advance use for medical, engineering, education, and/or other purposes. Second, because specialized graphics hardware/software is not needed, the size of the datasets is not limited by graphics processing unit (GPU) texture memory, memory swapping, and/or database scaling issues. Effectively, datasets are capable of unlimited size. Third, the column store nature of the in-memory database allows highly efficient image generation and increase application speed for 3D volume rendering. The high efficiency/speed allows the 3D rendering application to be used in a dynamic environment (e.g., real-time or near real-time) without long downtimes for rendering data. In some instances, 3D volume rendering can occur as data changes to provide a real-time view with accompanying analytics of the state of an object, etc. The rendering component is SQL based and provided by use of stored procedures in structured query language (SQL) SQLSCRIPT and/or procedural languages such as “L” that embed data-intensive application logic directly into the database at the database layer. Access/processing of data is simplified by the use of SQL statements and the use of complex computational languages to perform rendering functions can be avoided. Fourth, as the algorithms are in the database layer itself, there is no need to transfer extensive data across networks to render on remote hardware/software apart from the database. Fifth, an available web-based user interface allows the use of the 3D volume rendering application using a browser and/or mobile devices in a cloud-based computing environment. Expensive, custom applications and/or custom hardware workstations are not necessary to work with the datasets and to perform 3D volume rendering. Sixth, the user interface allows the selection of volume datasets available in the database and the selection of various rendering methods (e.g., intensity calculation based on average, maximum, first hit, etc.) as well as zooming and coloring of detected characteristics in the dataset. The user interface also allows for automatic intensity scaling where intensities are scaled from intensities provided by scanner systems to display intensities to generate the actual image data. Other advantages will be apparent to those skilled in the art.

Interactive Data Visualisation of Volume Datasets with Integrated Annotation and Collaboration Functionality

First, the generically described framework supports real-time interactive data visualisation of volume datasets with integrated annotation and collaboration functionality by utilizing the available speed and processing ability of an in-memory database. Second, the described functionality can be connected to existing clinical back-end systems, including hospital information systems and displays. For example, the described functionality can be implemented using mobile and cloud-computing infrastructures, providing healthcare professionals instant access to the electronic medical records of their patients and relevant information without having to search in paper-based patient information systems. Third, the described annotation and collaboration functionality can be made at a point-of-care (e.g., medical offices, hospitals, etc.) and on commonly available computing equipment (e.g., mobile devices, laptop/desktop computers, etc.) in a clear and easy-to-read format. This provides timely access to relevant patient data, intuitiveness of clinical information systems, and end-to-end support for all clinical processes. Thus, the workflows of the diagnosis processes are improved by bridging the gap between 3D scanning equipment already installed at hospital and clinics with electronic patient records. Fourth, medical personnel can interact online with the 3D volume data and gain better insights into the health status of patients and focus on regions of interest (e.g., interactively visualize tumors from various perspectives and drill down into a corresponding region of the body at interest). Fifth, multiple medical experts can, at any time, view, analyze, and discuss particular regions of interest in medical images remotely, regardless of location. As such, live collaborative sessions can be provided to analyze, annotate regions of interest within medical images, and ultimately help facilitate effective knowledge transfer and allow medical specialists to be reached at any time. Sixth, results of these collaborations can be attached as annotations to the images for documentation. Seventh, created annotations not only include text annotation, but also graphical annotations, clinical diagnostic information, and image content feature information. Eighth, the described integrated annotation and collaboration functionality allows experts to interactively explore, discuss, and annotate individual, patient related scans without creating and storing large amounts of image data in advance by technical experts on specialized graphics hardware. Rather than storing huge amounts of annotated image data during the diagnosis process, encoded bookmarks related to voxel positions in the original 3D volume dataset are created and stored. The bookmarks can be linked to annotations produced by domain experts and persisted in the database. Ninth, stored annotations can be matched to all images created for a region of interest and to form arbitrary viewing perspectives. This also dramatically reduces the amount of data stored in an electronic medical patient record. Tenth, annotations can be linked to positions in 3D data rather than annotating images in 2D image space. Thus, annotations are automatically linked to visualizations from the above-described arbitrary viewing positions showing the corresponding annotated region of interest. While in existing solutions, annotations are linked to one particular image, in the described subject matter, when accessing images showing the same region from another perspective (e.g., a different zoom level, angle, etc.), existing annotations can be configured to not be/not be accessible for the observer (e.g., since they are relevant/not relevant to the current perspective, due to privacy/permissions—such as membership in a particular collaborative-group, etc.). In some implementations, stored annotations can be matched to all images created for the corresponding region of interest from arbitrary perspectives; even images which will be generated at a future time from different perspectives or zoom levels can be automatically be linked to annotations created for visible regions. Eleventh, technically speaking the annotation system can operate in object space (i.e., 3D voxel data) rather than in a 2D image space.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system (EDCS) for providing three-dimensional (3D) volume rendering, according to an implementation.

FIG. 2 is a block diagram illustrating a lower-level view of the database of FIG. 1, according to an implementation.

FIG. 3 is a flow chart illustrating 3D volume rendering, according to an implementation.

FIG. 4 illustrates an example of using SQL to calculate average voxel intensity along a scanning ray path, according to an implementation.

FIG. 5 illustrates pixel illumination, according to an implementation.

FIG. 6 is an example of a visualization based on an average of scanned voxel intensities (X-ray mode), according to an implementation.

FIG. 7 is an example of visualization based on a maximum of scanned voxel intensities, according to an implementation.

FIG. 8 is an example of visualization based on slices of a volume, according to an implementation.

FIGS. 9A and 9B are examples of visualizations coloring regions of interest, according to an implementation.

FIG. 10 is a block diagram illustrating a lower-level view of the system and database of FIG. 1 as configured for integrated annotation and collaboration functionality, according to an implementation.

FIG. 11 is an example screenshot of an example GUI where a modification of a viewing angle and regions of interest associated with a 3D volume dataset are taking place while discussing visualized artifacts, according to an implementation.

FIG. 12 is an example screenshot of a visualization of an electronic medical record on a client computing device following rendering computations performed on a remote server-based rendering system providing open APIs, according to an implementation.

FIGS. 13A-13C are screenshots of a native implementation of a mobile-device user interface (UI) displaying electronic medical records through an open API provided by a remote server-based rendering system, according to an implementation

FIG. 14 is a screenshot of a generated textual annotation associated with a region of interest within a visualized medical image, according to an implementation.

FIG. 15 is a screenshot of interactive colorization of regions of interest in a 3D volume dataset, according to an implementation.

FIG. 16 is a flow chart of a method for setting a bookmark in a volume dataset associated with an electronic medical record according to an implementation.

FIG. 17 is a flow chart of a method for modifying a bookmark in a volume dataset associated with an electronic medical record, according to an implementation.

FIG. 18 is a flow chart of a method for collaboration with a volume dataset associated with an electronic medical record, according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

To provide, for example, at least the above-described and other advantages, this disclosure generally describes computer-implemented methods, computer-program products, and systems for three-dimensional (3D) volume rendering implemented by moving complex rendering algorithms and functionality into the database layer of an in-memory database. Additionally, the disclosure describes functionality providing interactive, real-time visualization of volume renderings that include integrated annotation and collaboration functionality.

Although the following description is focused on medical scanning/datasets and the use of an in-memory database, the described computer-implemented methods, computer-program products, and systems are also applicable to any type of 3D volume rendering (e.g., design, modeling, and analysis of buildings, machines (e.g., automobiles, aircraft, watercraft, etc.), DNA and other molecular structures (e.g., genetic diseases, medications, etc.), oil & gas exploration, financial analysis, and the like) as well as the use of a conventional database (although performance would be degraded due to the operation of the conventional database). The focus of the disclosure on medical datasets is to enhance understanding of the described subject matter and is not meant to limit the applicability of the described subject matter only to medical datasets and particularly those datasets described. Applicability to other types of datasets consistent with this disclosure is considered to be within the scope of this disclosure, particularly where integration/combination of data from generated images and human annotations are useful for the purposes of interactive discussions.

In scientific visualization and computer graphics, volume rendering is a set of techniques used to display a two-dimensional (2D) projection of a 3D discretely sampled dataset. A typical 3D dataset is a group of 2D “slice” images acquired by tools such as an X-ray computer tomography (CT), magnetic resonance imaging (MRI), a Micro-CT scanner, and/or other tools. 3D datasets can also be generated by software systems such as those used to design, model, and analyze buildings, machines (e.g., automobiles, aircraft, watercraft, etc.), DNA and other molecular structures (e.g., genetic diseases, medications, etc.), and the like. Current systems for volume rendering utilize specialized graphics hardware to process the huge amount of data produced by scanners. Typically, an end-user needs access to specialized, expensive, high-end workstations in order to work with and/or volume render the scanned datasets; therefore limiting the use of 3D volume renderings to specialists and particular groups of researchers. This has the effect of dampening the utilization of highly relevant, useful, and/or valuable 3D renderings, for example in medical diagnostics (e.g., cancer detection, neurological studies, research, etc.), engineering, education, and the like. Additionally, these volume rendering systems do not provide interactive, real-time visualization of volume renderings that include integrated annotation and collaboration functionality.

Volume datasets from a scanned object are usually acquired in a regular pattern (e.g., one data “slice” every millimeter). A volumetric grid is generated, with each volume element (a “voxel”) represented by a single value that is obtained by sampling the immediate area surrounding the voxel. A direct volume renderer requires every sample value to be mapped/composed to an opacity and a color (e.g., a red, green, blue, alpha (RGBA) value (or in some instances other value types)). This can be performed with a “transfer function” which can be a simple ramp, a piecewise linear function, and/or an arbitrary table. The composed RGBA value is projected on corresponding pixel of a frame buffer depending on the rendering technique used. The transfer function calculates a final color and a transparency of a pixel in a resulting image. The design of the transfer function depends heavily on what kind of visual effect should be achieved (e.g., one can choose to exclude certain voxels from a final image by using a piecewise linear function which maps certain values to not-visible and others to a defined color/opacity).

An in-memory database is a high-performance database management system (DBMS) that primarily relies on volatile electronic memory, such as random access memory (RAM), as opposed to magnetic, optical, removable, or other suitable non-electronic memory, for storage, retrieval, and processing of data. The reliance on electronic memory allows, in some implementations and in contrast to a conventional database, for near-real-time aggregation, replication, synchronization, and processing of data. In some implementations, a persistency layer ensures that a copy of the in-memory database is maintained on non-volatile magnetic, optical, removable, or other suitable non-electronic memory in the event of a power or other system failure in order to allow recovery of the in-memory database. In some implementations, the in-memory database can be coupled to a conventional database for various purposes such as backup, recovery, an interface, parallel processing, security, etc. In typical implementations, the described functionality is be performed by efficient structured query language (SQL) parallelization mechanisms on a column-store in-memory database (as opposed to a row-store operation on a conventional database).

Three-Dimensional Volume Rendering Using an In-Memory Database

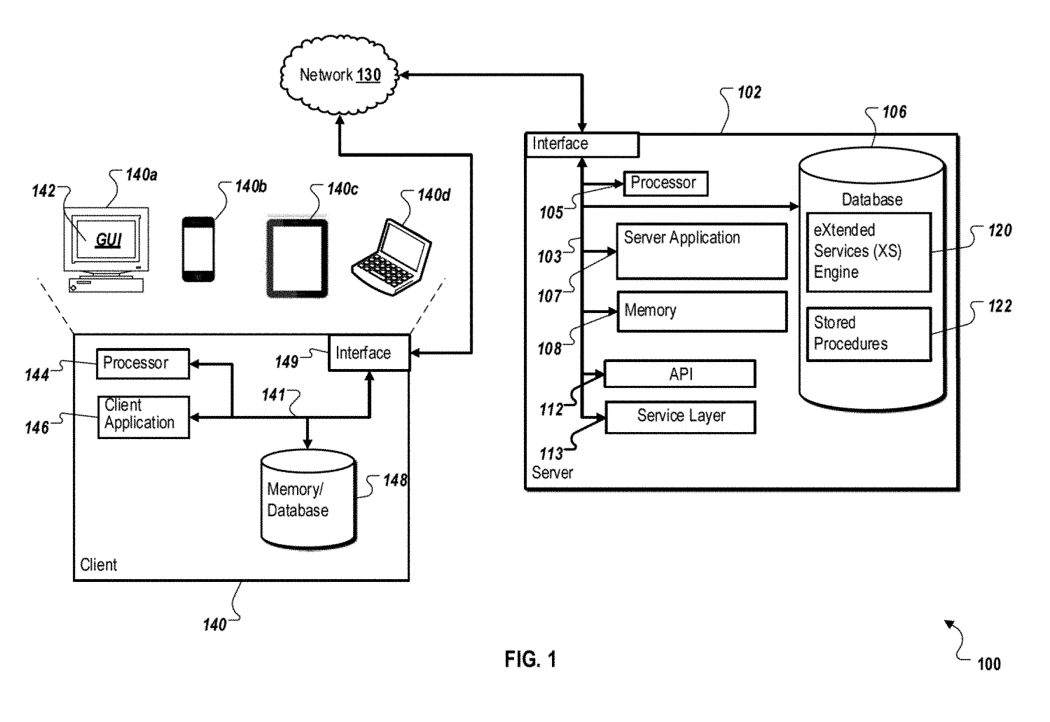

FIG. 1 is a block diagram illustrating an example distributed computing system (EDCS) 100 for providing 3D volume rendering and integrated annotation and collaboration functionality, according to an implementation. The illustrated EDCS 100 includes or is communicably coupled with a server 102 and a client 140 (an example of a computing device as mentioned above) that communicate across a network 130. In some implementations, one or more components of the EDCS 100 may be configured to operate within a cloud-computing-based environment.

At a high level, the server 102 is an electronic computing device operable to receive, transmit, process, store, or manage data and information associated with the EDCS 100. In general, the server 102 is a server providing at least functionality for three-dimensional (3D) volume rendering. According to some implementations, the server 102 may also include or be communicably coupled with an e-mail server, a web server, a caching server, a streaming data server, a business intelligence (BI) server, and/or other server.

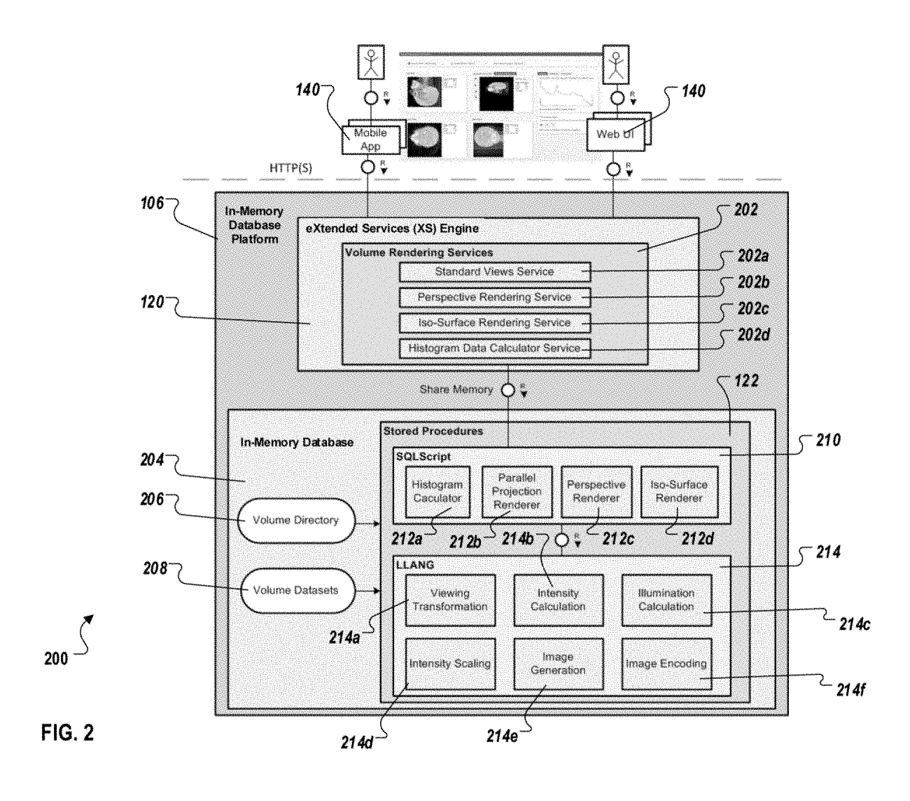

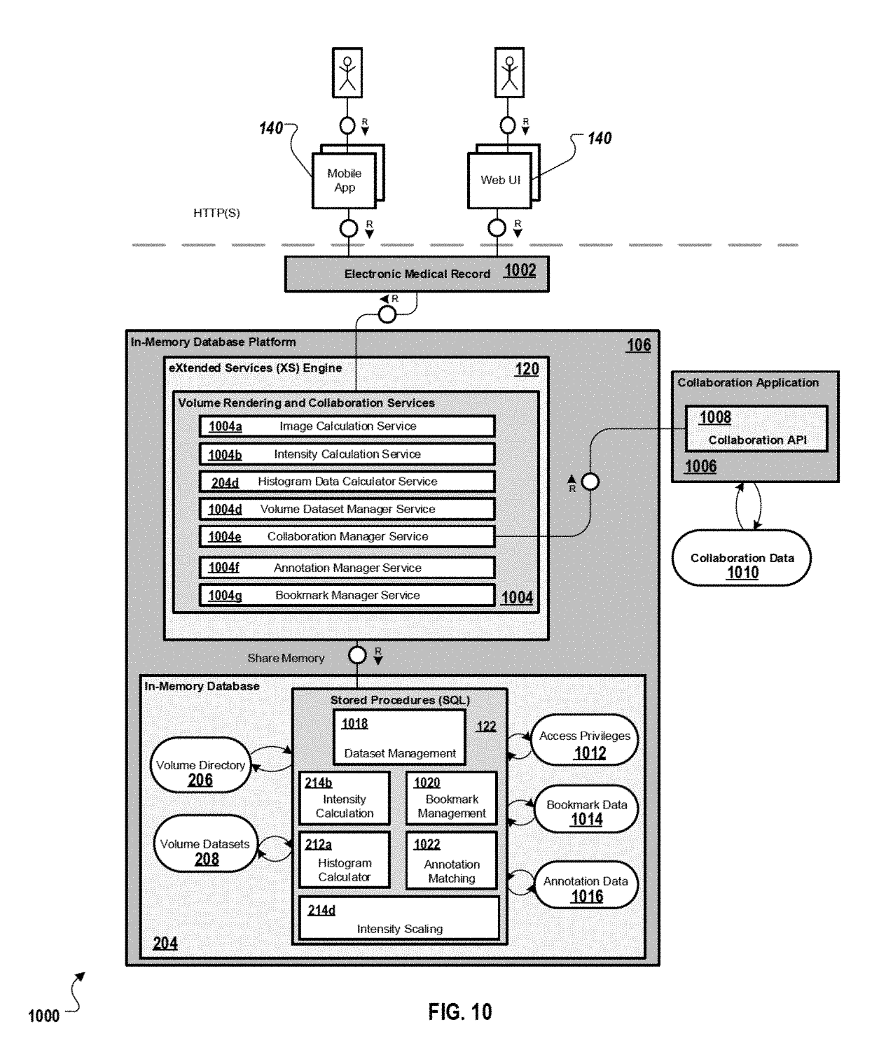

The server 102 is responsible for receiving and responding to, among other things, requests and/or content from one or more client applications 146 associated with the client 140 and other components of the EDCS 100 (see FIG. 2) and/or responding to the received requests and/or content. In some implementations, the server 102 processes the requests at least in the database 106 and/or the server application 107. In addition to requests received from the client 140, requests may also be sent to the server 102 from internal users, external or third-parties, other applications (e.g., refer to FIGS. 10-18 and associated description below for an enterprise collaboration application and associated API/data used for integrated annotation and collaboration functionality), as well as any other appropriate entities, individuals, systems, or computers. In some implementations, various requests can be sent directly to server 102 from a user accessing server 102 directly (e.g., from a server command console or by other appropriate access method).

Each of the components of the server 102 can communicate using a system bus 103. In some implementations, any and/or all the components of the server 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the EDCS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the EDCS 100, alternative implementations may illustrate the API 112 and/or the service layer 113 as stand-alone components in relation to other components of the EDCS 100. Moreover, any or all parts of the API 112 and/or the service layer 113 may be implemented as child or sub-modules of another software module, enterprise application, or hardware module without departing from the scope of this disclosure. For example, the API 112 could be integrated into the server application 107, and/or wholly or partially in other components of server 102 (whether or not illustrated).

The server 102 includes an interface 104. Although illustrated as a single interface 104 in FIG. 1, two or more interfaces 104 may be used according to particular needs, desires, or particular implementations of the EDCS 100. The interface 104 is used by the server 102 for communicating with other systems in a distributed environment—including within the EDCS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The server 102 includes a processor 105. Although illustrated as a single processor 105 in FIG. 1, two or more processors may be used according to particular needs, desires, or particular implementations of the EDCS 100. Generally, the processor 105 executes instructions and manipulates data to perform the operations of the server 102. Specifically, the processor 105 executes the functionality required for 3D volume rendering.

The server 102 also includes a database 106 that holds data for the server 102, client 140, and/or other components of the EDCS 100. In typical implementations, the database 106 is an in-memory database. Although illustrated as a single database 106 in FIG. 1, two or more databases may be used according to particular needs, desires, or particular implementations of the EDCS 100. While database 106 is illustrated as an integral component of the server 102, in alternative implementations, database 106 can be external to the server 102 and/or the EDCS 100. In some implementations, database 106 can be configured to store one or more instances of and/or some or all data for an eXtended Services (XS) engine 120 (described in relation to FIG. 2), stored procedures 122 (described in relation to FIG. 2), and/or other appropriate data (e.g., user profiles, objects and content, client data, etc.).

The server application 107 is an algorithmic software engine capable of providing, among other things, any function consistent with this disclosure for 3D volume rendering, for example receiving one or more requests from a client 140, relaying the request to the database 106, and relaying response data to the client 140 response to the received one or more requests, providing administrative functionality for the server 102 (e.g., particularly with respect to the database 106 and with respect to functionality for 3D volume rendering). In some implementations, the server application 107 can provide and/or modify content provided by and/or made available to other components of the EDCS 100. In other words, the server application 107 can act in conjunction with one or more other components of the server 102 and/or EDCS 100 in responding to a request received from the client 140 and/or other component of the EDCS 100.

Although illustrated as a single server application 107, the server application 107 may be implemented as server applications 107. In addition, although illustrated as integral to the server 102, in alternative implementations, the server application 107 can be external to the server 102 and/or the EDCS 100 (e.g., wholly or partially executing on the client 140, other server 102 (not illustrated), etc.). Once a particular server application 107 is launched, the particular server application 107 can be used, for example by an application or other component of the EDCS 100 to interactively process received requests. In some implementations, the server application 107 may be a network-based, web-based, and/or other suitable application consistent with this disclosure.

In some implementations, a particular server application 107 may operate in response to and in connection with at least one request received from other server applications 107, other components (e.g., software and/or hardware modules) associated with another server 102, and/or other components of the EDCS 100. In some implementations, the server application 107 can be accessed and executed in a cloud-based computing environment using the network 130. In some implementations, a portion of a particular server application 107 may be a web service associated with the server application 107 that is remotely called, while another portion of the database engine 107 may be an interface object or agent bundled for processing by any suitable component of the EDCS 100. Moreover, any or all of a particular server application 107 may be a child or sub-module of another software module or application (not illustrated) without departing from the scope of this disclosure. Still further, portions of the particular server application 107 may be executed or accessed by a user working directly at the server 102, as well as remotely at a corresponding client 140. In some implementations, the server 102 or any suitable component of server 102 or the EDCS 100 can execute the server application 107.

The client 140 may be any computing device operable to connect to and/or communicate with at least the server 102. In general, the client 140 comprises an electronic computing device operable to receive, transmit, process, and store any appropriate data associated with the EDCS 100, for example, the server application 107. More particularly, among other things, the client 140 can collect content from the client 140 and upload the collected content to the server 102 for integration/processing into/by the server application 107 and/or database 106. The client typically includes a processor 144, a client application 146, a memory/database 148, and/or an interface 149 interfacing over a system bus 141.

The client application 146 is any type of application that allows the client 140 to navigate to/from, request, view, create, edit, delete, administer, and/or manipulate content associated with the server 102 and/or the client 140. For example, the client application 146 can present graphical user interface (GUI) displays and associated data to a user generated by the server application 107 and/or database 106, accept user input, and transmit the user input back to the server 102 for dissemination to the appropriate components of server 102, in particular the server application 107 and/or the database 106. In some implementations, the client application 146 can use parameters, metadata, and other information received at launch to access a particular set of data from the server 102 and/or other components of the EDCS 100. Once a particular client application 146 is launched, a user may interactively process a task, event, or other information associated with the server 102 and/or other components of the EDCS 100. For example, the client application 146 can generate and transmit a particular request to the server 102.

In some implementations, the client application 146 can also be used perform administrative functions related to the server application 107 and/or database 106. For example, the server application 107 and/or database 106 can generate and/or transmit administrative pages to the client application 146 based on a particular user login, request, etc.

Further, although illustrated as a single client application 146, the client application 146 may be implemented as multiple client applications in the client 140. For example, there may be a native client application and a web-based (e.g., HTML) client application depending upon the particular needs of the client 140 and/or the EDCS 100.

The interface 149 is used by the client 140 for communicating with other computing systems in a distributed computing system environment, including within the EDCS 100, using network 130. For example, the client 140 uses the interface to communicate with a server 102 as well as other systems (not illustrated) that can be communicably coupled to the network 130. The interface 149 may be consistent with the above-described interface 104 of the server 102. The processor 144 may be consistent with the above-described processor 105 of the server 102. Specifically, the processor 144 executes instructions and manipulates data to perform the operations of the client 140, including the functionality required to send requests to the server 102 and to receive and process responses from the server 102.

The memory/database 148 typically stores objects and/or data associated with the purposes of the client 140 but may also be consistent with the above-described database 106 of the server 102 or other memories within the EDCS 100 and be used to store data similar to that stored in the other memories of the EDCS 100 for purposes such as backup, caching, and the like.

Further, the illustrated client 140 includes a GUI 142 that interfaces with at least a portion of the EDCS 100 for any suitable purpose. For example, the GUI 142 (illustrated as associated with client 140a) may be used to view data associated with the client 140, the server 102, or any other component of the EDCS 100. In particular, in some implementations, the client application 146 may render GUI interfaces and/or content for GUI interfaces received from the server application 107 and/or database 106.

There may be any number of clients 140 associated with, or external to, the EDCS 100. For example, while the illustrated EDCS 100 includes one client 140 communicably coupled to the server 102 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140d) is intended to encompass any computing device such as a desktop computer/server, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142 (illustrated by way of example only with respect to the client 140a).

FIG. 2 is a block diagram 200 illustrating a lower-level view of the database 106 (database layer) of FIG. 1, according to an implementation. The XS Engine 120 in the XS engine layer provides services for volume rendering. For example, volume rendering services 202 can include a standard views service 202a, perspective rendering service 202b, ISO-surface rendering service 202c, and histogram data calculator service 202d. In other implementations, more or less services consistent with this disclosure can also be included in the volume rendering services 202. In some implementations:
The standard views service 202a calculates images for viewer directions along the major coordinate axes. Typically, the volume cannot be rotated in this viewing mode.
The perspective rendering service 202b calculates images for volume datasets, which are arbitrarily rotated and translated. Typically, this service implements a classic viewing pipeline required for rendering 2D projections of 3D scenes.
The ISO-surface rendering service 202c only renders voxels with a given intensity. Hence, for an ISO-surface, all voxels on the surface have the same intensity value. In order to visualize them, an illumination calculation system can be leveraged (see below).
The histogram data calculator service 202d is needed to calculate how many voxels with a certain gray-value are present in a volume. Among internal statistical operations, the histogram data calculator service is needed for user defined transfer functions, where the user can clip away voxel values in order to highlight/segment parts of the volume dataset (e.g., only show bones, teeth, liver etc.).

The in-memory database 106 includes a volume directory 206, volume datasets 208, and stored procedures 122. The volume directory 206 contains a directory of available datasets for rendering. The volume datasets 206 are typically created by scanning equipment as described above (e.g., CT, MRI, etc.). The volume datasets 206 are in the form of a data cube (e.g., a three or higher dimensional array of values commonly used to describe a time series of image data) including a multitude of sample points generated by the above-described scanning equipment hardware.

In the illustrated XS engine 120, the stored procedures 122 include both SQLSCRIPT procedures 210 and L-language (LLANG) procedures 214 used, for example, to process, extract, visualize (generate images), analyze etc. data from the volume datasets 208. For example, a user may wish to extract a scanned region of a human head from a data cube and perform analysis on the extracted data. The stored procedures 122 can be used to do so. In some implementations, one or more patterns can be extracted from the volume datasets 208 and be used to perform pattern matching, predictive analysis, and other functions. In other implementations, the stored procedures can be written in any appropriate language or format consistent with this disclosure.

In the illustrated stored procedures 122, the SQLSCRIPT procedures 212 can include a histogram calculator 212a, parallel projection renderer 212b, perspective renderer 212c, and/or an ISO-surface renderer 212d. In some implementations:
The histogram calculator 212a uses SQL aggregate functions to count and classify voxel intensities. It can also perform, if needed, a mapping from a source data range to a specified destination data range (e.g., a source could be 16-bit gray-value resolution and a target could be defined as 8-bit gray-value resolution.)
The parallel projection renderer 212b uses plain SQL statements for implementing a basic ray-casting along the major coordinate system axis.
The perspective renderer 212c implements the complete viewing pipeline (view-model transform, viewport mapping). Matrix multiplication is done in LLANG, the results are passed back to SQL.
The ISO-surface renderer 212d calculates the ISO-surface for a given intensity value along one the major coordinate axes and utilizes illumination calculator 214c to show an highlight features on the ISO-surface.

The LLANG procedures 214 are lower-level code procedures that can be called by SQL stored procedures (e.g., the SQLSCRIPT procedures 212) to perform particular “heavy-weight” (high computational) functions. The LLANG procedures 214 can include procedures for viewing calculator 214a, intensity calculator 214b, illumination calculator 214c, intensity scaling calculator 214d, image generator 214e, and/or image encoding calculator 214f. In some implementations (for the illumination calculator 214c) for a correct viewer-direction-dependent illumination, several factors must be calculated. Additional sample points must be acquired using, for example, tri-linear interpolation, and intersection points must be computed. Note that these are complex operations and cannot be done with the SQL language. The results are calculated in the L LANG layer and are passed back to the SQL layer.

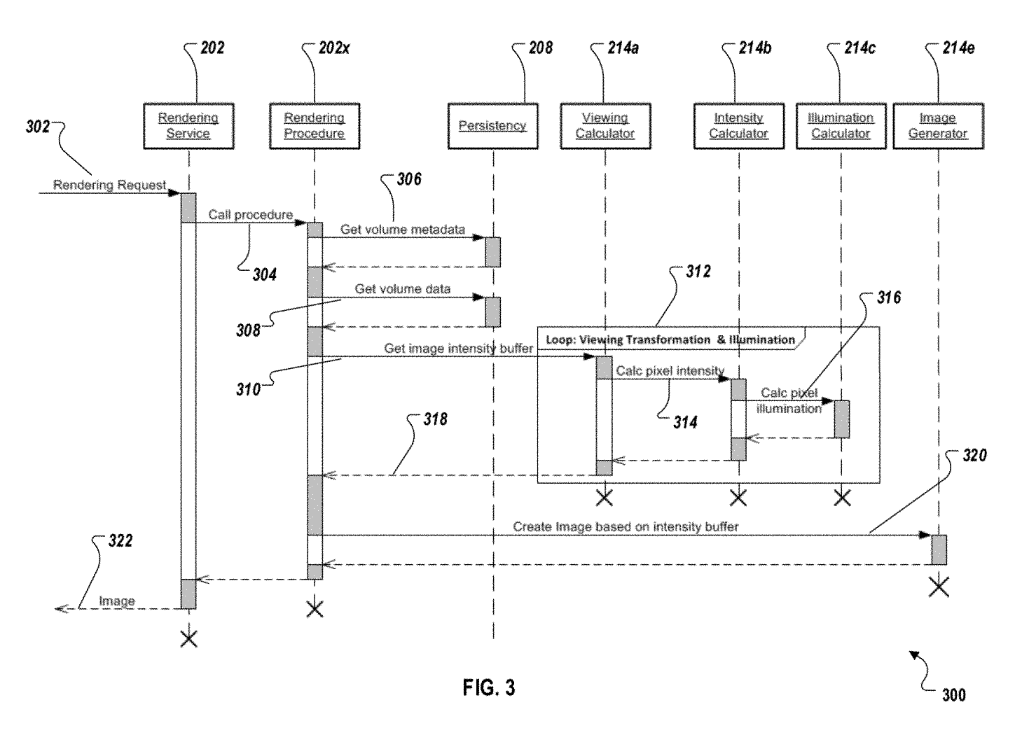

FIG. 3 is a flow chart 300 illustrating 3D volume rendering, according to an implementation. For clarity of presentation, the description that follows generally describes flow 300 in the context of FIGS. 1-2, 4-8, 9A & 9B, 10-12, 13A-13C, and 14-18. However, it will be understood that flow 300 may be performed, for example, by any other suitable system, environment, software, and hardware, or a combination of systems, environments, software, and hardware as appropriate. In some implementations, various steps of flow 300 can be run in parallel, in combination, in loops, and/or in any order.

At 302, a rendering request (e.g., in hypertext transfer protocol (HTTP)—but any protocol is envisioned as acceptable) is received by the volume rendering services 202 for a rendered image. The GUI that issued the request will expect an image to be return in response to the rendering request. The XS Engine 120 volume rendering service 202 analyzes the received request to determine a particular rendering service(s) to be leveraged (e.g., for rendering a histogram using the histogram data calculator service 202d). From 302, flow 300 proceeds to 304.

At 304, the particular rendering procedure(s) determined from the rendering request is called (e.g., the histogram data calculator service 202d). From 304, flow 300 proceeds to 306.

At 306, volume metadata is retrieved from the persistency (volume datasets 208) using the volume directory 206 to locate the appropriate volume metadata. For example, metadata related to stored medical data (e.g., models of brain, head, etc.), engineering data (e.g., engines, etc.), data format (e.g., RAW, etc.), size in X, Y, and Z-axis directions, number of sample points, sample distance, patient name, etc. From 306, flow 300 proceeds to 308.

At 308, the rendering procedure(s) retrieves volume data from the persistency using the volume directory 206 to locate the data. From 308, flow 300 proceeds to 310.

At 310, the rendering procedure(s) calls appropriate stored procedure(s) 122 to perform the requested rendering (e.g., the histogram calculator 212a in the SQLSCRIPT stored procedures 210). The data is operated on using SQL statements. For example, in the illustrated example, the rendering procedure generates an image intensity buffer by executing SQLSCRIPT 212 procedures/LLANG procedures 214 in a loop 312 to create intensity buffer data from the volume dataset 208. An image intensity buffer is requested from an instance of the viewing calculator 214a. Note that the viewing calculator 214a in FIG. 2 is a stored procedure that performs one particular step of viewing calculations. For example, during this step, 3D coordinates of an object in an object space are transformed/mapped to an image space (2D). This can be compared to a camera model, where the objects of the real world environment (3D) are mapped/projected onto the film (negative) which is the base for a final image. The image intensity buffer is a data structure (e.g., an array and/or other data structure) which stores calculated intensity values (e.g., performed by intensity calculator 214b of FIG. 2). The intensity buffer is transferred between several stored procedures to calculate a final image to display (e.g., typically all components of the LLANG 214 of FIG. 2). The viewing calculator 214a is able to create a view of image data from an “eye point” in 3D space. For example, if a user was slightly back and to the left of a scanned object, the eye point would be in this position looking in the direction of the scanned object and the viewing calculator 214a would be responsible to calculate at least the pixel intensity and pixel illumination for all pixels in the portion of the volume dataset 208 applicable to the requested rendering. Note that there is space/distance between sample points in the scanned volume dataset and interpolation from both the pixel intensity and pixel illumination (both described below) must also be taken into account and projected to “fill” in the space around each sample point.

In more detail, an intensity buffer stores calculated intensity-values for each pixel in an image space. Usually intensities are in a range (e.g., [0, Max-Intensity]) where 0 means no intensity (or translated to background color). The intensity buffer is calculated by projecting the model (e.g., a 3D scan) into the image space by taking into account an actual position of the observer (eye) and a viewing direction. This is actually a camera model where the camera observes a 3D environment and the picture is a 2D projection of the real environment. In the case of the volume data visualization, the intensity values are the scanned intensities (e.g., as measured by a scanner—MRT, CT, etc.). The scanner produces a 3D model of the scanned object where the intensities are stored in a 3D cube (voxels). During perspective rendering, these intensity values are projected on 2D plane (e.g., a viewing plane which is rasterized in pixels arranged in rows and columns). At the end of the projection phase, the intensity-buffer stores the intensity values for visible parts of the scanned object from a give perspective. These intensities are then translated into color values based on a given color model (e.g., RGB or other color model). These calculated pixel color values are then encoded into a specified image file format (e.g., BMP, JPEG, TIF, PNG, etc.) by Imaging Encoding module 214f. Note that with respect to FIG. 2, an intensity calculation is a combination of the viewing calculator 214a (projection), intensity calculator 214b (interpolation of intensity values), and the intensity scaling calculator 214d. Intensity scaling is used to map between a source gray-value range and a target gray-value range. For example, if a the volume dataset created by the scanner has a 16-bit resolution, but a final image can only be displayed with a resolution of 8-bit, then a mapping needs to be performed between the different intensity value ranges (gray-value ranges). This mapping is performed by the intensity scaling module 214d. From 312, flow 300 proceeds to 314.

At 314, the intensity of each pixel (to distinguish/match it with other associated pixels) in the requested portion of the volume dataset is calculated by the intensity calculator 214b. Each sample point created by a scanner (e.g., a CT scanner) has a particular intensity value associated with it (e.g., due to the absorption of X-rays in the case of the CT scanner) that is mapped, for example, to a gray value for display. For example, intensity might be a float value from 0 to 1 (as 8, 16, 32-bit values, etc.) but it could be any value.

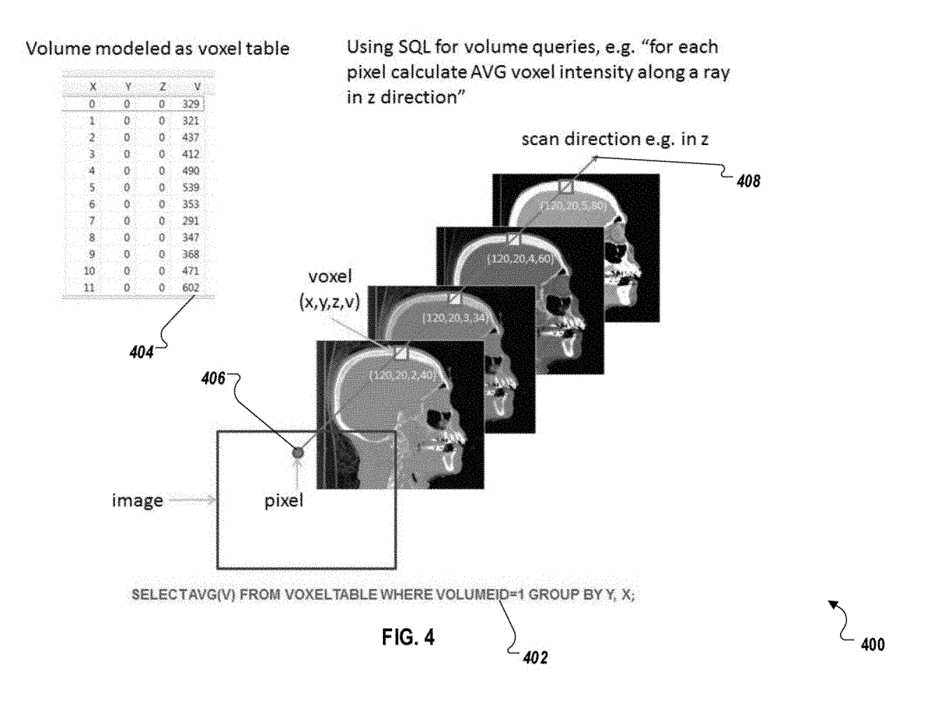

Referring to FIG. 4, FIG. 4 illustrates an example 400 of using SQL to calculate average voxel intensity along a scanning ray path, according to an implementation. In the provided example, intensity values are calculated for three main viewing axes (top, front, side).

In some implementations, the following SQLSCRIPT calculates the intensities based on the maximum intensity approach:

IF PERSPECTIVE=‘FRONT’ THEN
DATA_INTENSITIES=SELECT TO_DECIMAL(MAX(V)) as INTENSITY FROM “VOXEL_SCHEMA”.“volumerenderer.data::volumes” where “VOLUMEID”=:VOLUMEID group by X, Y ORDER BY Y, X;

ELSEIF PERSPECTIVE=‘TOP’ THEN
DATA_INTENSITIES=SELECT TO_DECIMAL(MAX(V)) as INTENSITY FROM “VOXEL_SCHEMA”.“volumerenderer.data::volumes” where “VOLUMEID”=:VOLUMEID group by Z, X ORDER BY Z DESC, X;

ELSEIF PERSPECTIVE=‘SIDE’ THEN
DATA_INTENSITIES=SELECT TO_DECIMAL(MAX(V)) as INTENSITY FROM “VOXEL_SCHEMA”.“volumerenderer.data::volumes” where “VOLUMEID”=:VOLUMEID group by Y, Z ORDER BY Y, Z;

END IF.

In some implementations, the following SQLSCRIPT calculates the intensities based on the average intensity approach (X-ray type images):

IF PERSPECTIVE=‘FRONT’ THEN
DATA_INTENSITIES=SELECT AVG(V) as INTENSITY FROM “VOXEL_SCHEMA”.“volumerenderer.data::volumes” where “VOLUMEID”=:VOLUMEID group by X, Y ORDER BY Y, X;

ELSEIF PERSPECTIVE=‘TOP’ THEN
DATA_INTENSITIES=SELECT AVG(V) as INTENSITY FROM “VOXEL_SCHEMA”.“volumerenderer.data::volumes” where “VOLUMEID”=:VOLUMEID group by Z, X ORDER BY Z DESC, X;

ELSEIF PERSPECTIVE=‘SIDE’ THEN
DATA_INTENSITIES=SELECT AVG(V) as INTENSITY FROM “VOXEL_SCHEMA”.“volumerenderer.data::volumes” where “VOLUMEID”=:VOLUMEID group by Y, Z ORDER BY Y, Z;

END IF.

The calculations are performed for a volume specified by a volume-id 402 (here “1”). The intensity values V 404 for each pixel 406 (values+intensity illustrated in the table associated with 404) are generated by a scanner such as a PET, MRT, CT, MRI, etc. and stored for so called voxels specified by the coordinates (X, Y, Z) in 3D space. Generally, the algorithms operate as follows: “for each pixel in the final image, orient a ray perpendicular to the image plane through the volume layers. Along the ray collect sample values and perform an operation on the sample values. The resulting value is used as color value for the pixel in the resulting image.” The algorithm itself is encapsulated in the SQL statement.

For example, if the scanner produces a scan with resolution 256×256×128, there can be 128 intensity layers where each layer contains 256×256 intensity values. The voxels form a 3D data cube and the observer can look at the model along the X, Y, or Z-axis 408. The intensity values can be calculated by using specified SQL-statements and, based on the calculated intensities; the final image (e.g., .PNG, .BMP, JPG) is (as described below) calculated and passed back to a GUI for display.

Note that perspective- and ISO-rendering require more sophisticated algorithms that are implemented deeper in the database layer as previously-described LLANG procedures (e.g., LLANG 214) as SQL-statements alone are not sufficient to perform these calculations. Returning to FIG. 3, From 314, flow 300 proceeds to 316.

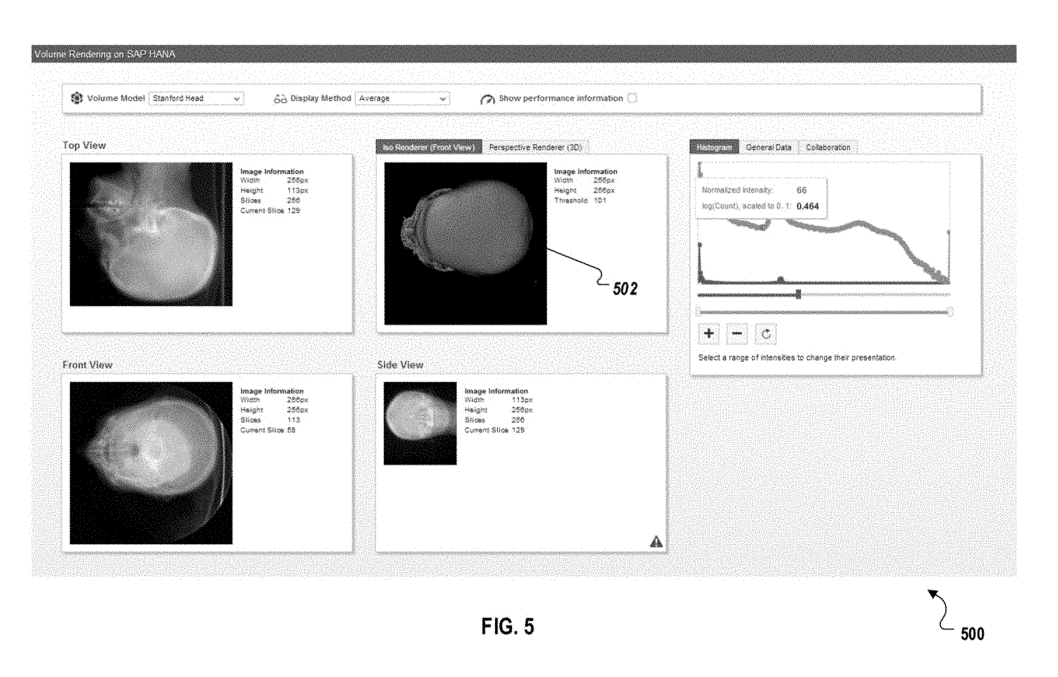

At 316, the pixel illumination value for the pixel of 314 is calculated by the illumination calculator 214c. The illumination values are used to highlight a shape to provide a simulated lighting. The illumination calculator takes the intensity value and performs a gradient calculation to generate geometric vectors to perform a basic illumination. Referring to FIG. 5, FIG. 5 illustrates pixel illumination 500, according to an implementation. For example, image 502 is generated by an ISO Renderer as a perspective 3D view. The illumination of each pixel is calculated to simulate lighting from the upper area of the skull (right side of the head) which causes shading on various parts of the skull surface.

Returning to FIG. 3, after the pixel illumination value is determined, it is determined if another pixel is to be processed. If there are additional pixels, they are processed according to 314 and 316. If there are no further pixels to be processed, the intensity buffer is returned to the rendering procedure at 318. From 318, flow 300 proceeds to 320.

At 320, an image is created from the intensity buffer by the image generator 214e. The image generator 214e encodes the pixel intensities and pixel illumination values into an image format and returns the encoded image to the rendering service 202 where it is returned to the rendering requestor at 322. In some implementations, a bitmap (.BMP) formatted image file is returned. In other implementations, any other (including more than one) image formatted file may be returned to the requestor. After 322, flow 300 stops.

The volume rendering system supports different visualization modes for various use cases. As a result, corresponding intensities are efficiently calculated by the volume rendering system depending on the following (or other) visualization modes. The following examples do not represent all possible rendering modes and are presented not to limit but to help with understanding of the described subject matter.

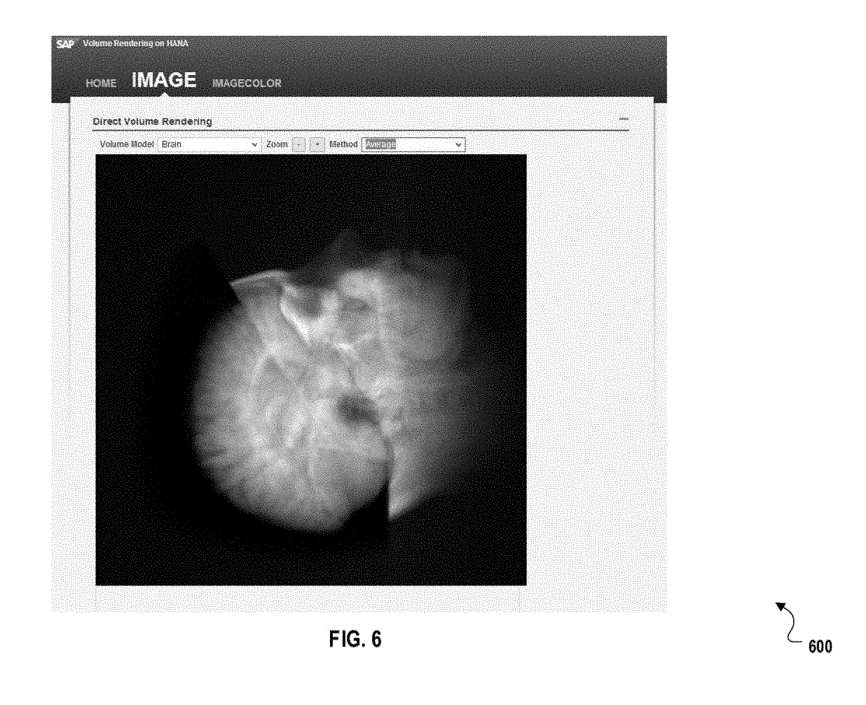

For example, referring to FIG. 6, FIG. 6 is an example of a visualization 600 based on an average of scanned voxel intensities (X-ray mode), according to an implementation (see also the average intensity approach SQL example above).

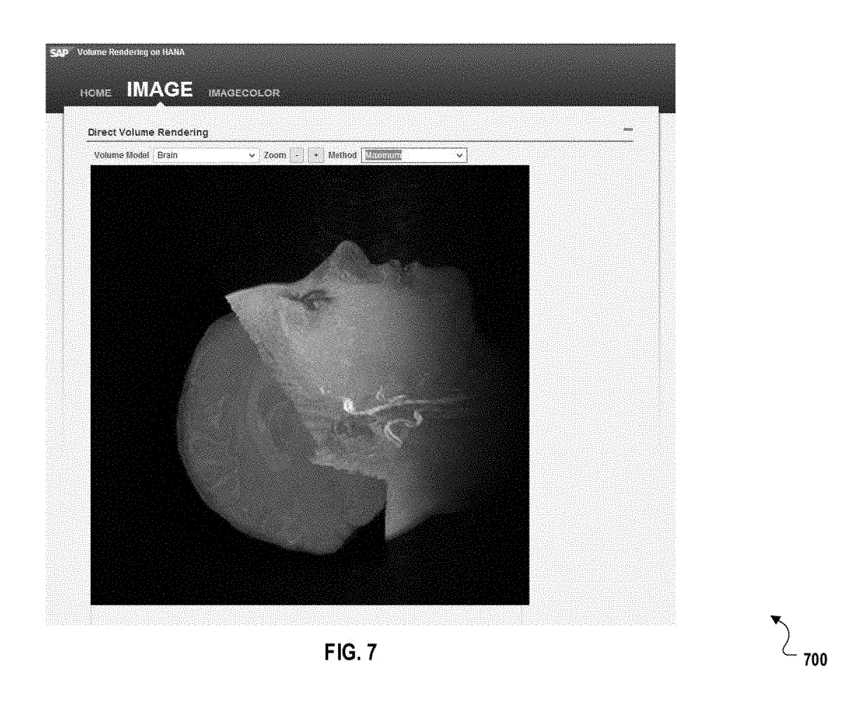

FIG. 7 is an example of visualization 700 based on a maximum of scanned voxel intensities, according to an implementation (see also the maximum intensity approach SQL example above).

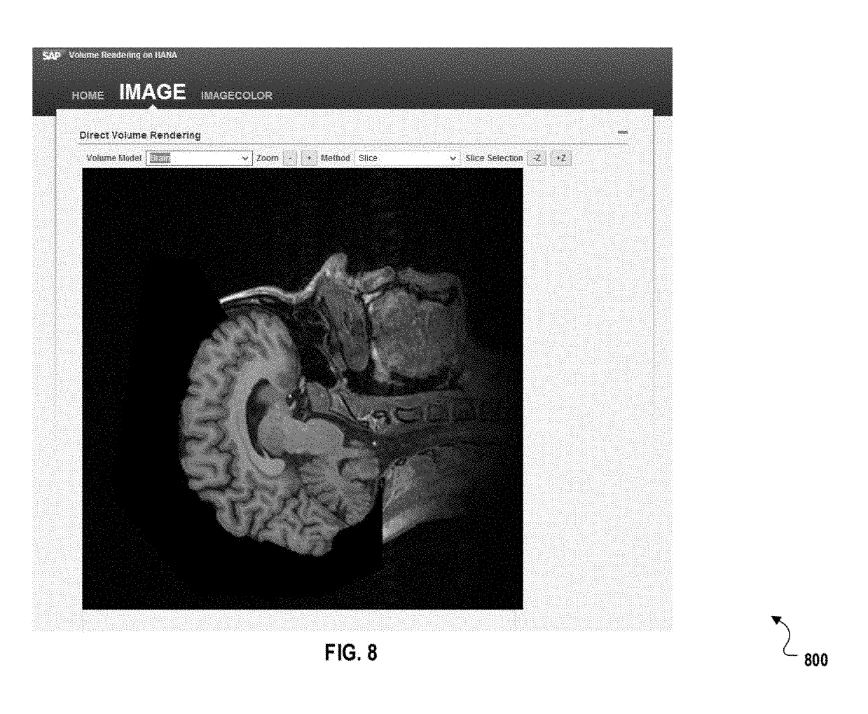

FIG. 8 is an example of visualization 800 based on slices of a volume, according to an implementation. As can be seen, the image is as if a slice was removed from a human head and viewed to show brain structure, bone, etc.

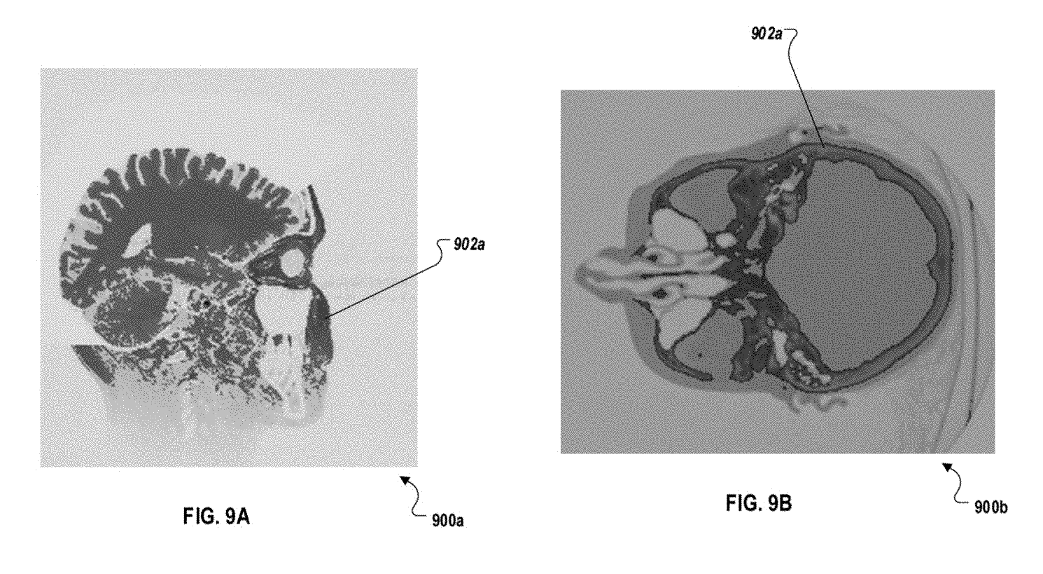

FIGS. 9A and 9B are examples of visualizations 900a and 900b coloring regions of interest, according to an implementation. Colorization is performed by choosing intensities of specific values and mapping the intensities to particular colors. Although illustrated in black and white with various shading and/or patterns, as can be seen in FIG. 9A, bone structure 902a in the slice image can be visually displayed in color (e.g., green or other color) to make it stand out. Similarly in FIG. 9B, bone structure 902b from the top view can be visually displayed in color (e.g., red or other color) to make it stand out.

Interactive Data Visualisation of Volume Datasets with Integrated Annotation and Collaboration Functionality

FIG. 10 is a block diagram 1000 illustrating a lower-level view of the system and database 106 (database layer) of FIG. 1 as configured for integrated annotation and collaboration functionality according to an implementation. At a high level, the illustrated architecture focuses on the integration of an in-memory-based image rendering system (e.g., that described in FIGS. 1-9B) with an enterprise collaboration application and annotation functionality in order to provide integrated visualization, collaboration and annotation functionality. As stated above, although the following description is focused on medical scanning/datasets and the use of an in-memory database, the described computer-implemented methods, computer-program products, and systems are also applicable to other types of 3D volume rendering and/or database technologies, as will be apparent to those of ordinary skill in the art.

FIG. 10 illustrates one example of a software/hardware configuration meant to enhance understanding the concepts described in this disclosure and is not meant to limit the disclosure in any way. Note that FIG. 10 is in some manner similar to FIG. 2. In this illustration, FIG. 10 is illustrated with elements identical or similar to those from FIG. 2 to enhance understanding, and readers should generally refer back to prior descriptions (e.g., associated with FIGS. 1-9B) of components not repeated in the description of FIG. 10. However, as will be understood by those of ordinary skill in the art, FIG. 10 does not necessarily show all components present in FIG. 2 and may, in other implementations, include more or less components (e.g., components may be omitted, added, combined, etc.) necessary to perform more or less of the described functionalities of FIG. 2. Also, while some components of FIG. 10 are illustrated as identical or similar to those of FIG. 2, in some implementations, some or all of the components illustrated in FIG. 10 can be configured to perform some or all of their functionality differently from those indicated as identical or similar to those of FIG. 2. Note that the enterprise collaboration application/API and collaboration data is not indicated on FIG. 1 for simplicity. In this example, collaboration application/API, data would be generally be shown interoperably connected to database 106.

For the purposes of the described integrated annotation and collaboration functionally, it is assumed that any necessary medical/clinical data sources are integrated into the illustrated electronic medical record 1002 by utilizing corresponding APIs of an electronic medical record solution (e.g., 1002) and relevant adapters (e.g., software, network, data, etc.) to legacy data systems (e.g., here—medical/clinical systems). In some implementations, the illustrated electronic medical record 1002 is a computational solution providing a digital version of a paper medical chart that contains standard medical and clinical data gathered into a central storage and enabling simple and secure access to relevant patient data right at the point of care for relevant medical personnel. The example electronic medical record 1002 solution can connect to existing clinical back-end systems, including hospital information systems, and can display relevant data for each patient on a mobile and other devices (e.g., smartphones and tablets) in a clear and easy-to-read format.

The basic challenges of healthcare (and, as stated above, other types of 3D volume rendering data), include, but not limited to:
Increasing timely access to relevant patient data at the point of care,
Enhancing intuitiveness of clinical information systems, electronic medical records, and presented data, and
Providing end-to-end support for all clinical processes

One outstanding problem is an interactive, real-time visualization of volume data with integrated collaboration and annotation functionality that seamlessly integrates into existing electronic medical record systems where experts can interactively explore, discuss and annotate individual, patient related data (e.g., CT/MRI scans) and diagnostic workflows are enhanced by bridging the gap between 3D scanning equipment already installed at hospitals and clinics with electronic patient records.

The medical industry continues to rely on technologies and practices that predate the Internet and other networks. Images (e.g., from a CT or MRI scan) are typically saved to a DVD and physically transported from one facility to another, or scanners may only connect to computers on-premises using non-standardized networking protocols. The utilization of a cloud-based solution for extended electronic medical records has a high potential for improving diagnostic workflows. The proposed platform makes diagnostic processes more efficient without requiring massive upgrades to infrastructure. It also provides medical personnel access to assistance from experts (e.g., radiology, ophthalmology, pathology, oncology, and cardiology) all over the world, and who can easily and intuitively access a particular electronic patient record with an integrated interactive visualization of volume data on a mobile devices rather than waiting a DVD or hard copy of medical scans to arrive at a remote physical location.

As stated above, the described volume data is a 3D dataset typically generated by a scanner (e.g., a CT, MM, or MicroCT). These scanners typically produce a series of 2D image slices. The 2D slices then form a stack in form of a cuboid which makes up a particular volume. Each element of a volume dataset is called a voxel (a volumetric element-basically a 3D pixel). The generated datasets can get very large in size and pose a challenge for efficient processing. For example, a modern scanner can produce 2D images with a dimension of 2048×2048 pixels. The gray value (intensity) can be encoded with 32-bit precision. The resulting single 2D image size would be 2048×2048×4=16.777.216 bytes=16 MB. A typical example scan can consist of up to one-thousand slices, which results, in this example, of a total volume size of 16 GB. Due to the size of this volume dataset, it is hard to keep the data completely in memory (e.g., system RAM) on commonly available hardware. In order to efficiently visualize and analyze such datasets, many complex optimization tricks often need to be performed.

The illustrated volume rendering and collaboration services 1004 includes, among other services, particular services used to provide the above-described integrated annotation and collaboration functionality. In typical implementations, all services are representational state transfer (REST)-ful services, where associated resources (e.g. bookmarks, annotations, etc.) can be identified by uniform resource locators and communications are based on the HTTP protocol. In other implementations, other types of services, locators, or communication protocols can be used. In the described implementation, the REST-ful services offer the typical CRUD (create, read, update, and delete) operations for corresponding exposed resources. In one implementation, Open Data Protocol (OData) can be used to implement open REST-APIs of the described REST-ful services. In typical implementations, the volume rendering and collaboration services 1004 include an image calculation service 1004a, intensity calculation service 1004b, histogram data calculator service 202d (previously described), volume dataset manager service 1004d, collaboration manager service 1004e, annotation manager service 1004f, and bookmark manager service 1004g.

The image calculation service 1004a and intensity calculation service 1004b (together generally a “remote rendering service”) are used to generally calculate, as described above, a 2D representation of 3D data (the actual image and associated intensity of any of the varied pixels that make a calculated image for display—e.g., 2D image simulating a 3D view of volume data). In typical implementations, the remote rendering service is directly integrated in the database layer as part of the in-memory database platform 106 and expose remote rendering functionality using a REST-API. In typical implementations, the image/intensity calculations in FIG. 2 are subroutines implemented in a special implementation language (LLANG) provided as part of the in-memory database 204, which allow very fast in-memory calculations based on the data persisted in the in-memory database 204. These routines are not services on their own, but are used by renderers (e.g., implemented in SQL-Script) which in turn are used by rendering services running inside the XS engine 120. The image/intensity calculations are based on standard algorithms used by regular rendering applications (e.g., running on desktop PCs, etc.). In contrast, in FIG. 10, there is a dedicated image calculation service 1004a and an intensity calculation service 1004b. These two services can be considered “sub-services” of the standard views service, perspective rendering service, etc. of FIG. 2, and performing image and intensity calculations for specialized views (e.g., standard, perspective, ISO, etc.). The two services can also be considered “wrapper” services for corresponding subroutines in the stored procedures 122. These services can then be reused by the standard views service 202a, the perspective rendering service 202b, etc. in FIG. 2.

In typical implementations, the remote rendering service provides a generic GUI for desktops and mobile devices allowing integration with existing electronic medical records systems (e.g., using the HTTPS and/or other protocol. A particular implementation can integrate a GUI launchpad into the electronic medical record 1002 which can launch one or more corresponding applications (e.g., client and/or server-based applications) to provide visualization and collaboration functionality. In some implementations, UI' s to provide visualization and collaboration functionality can be executed in and provided through a cloud-based computing environment.

The volume dataset manager service 1004d is realized as a set of stored procedures which provide fast access to stored datasets (e.g., voxel models produced by a CT scan). The stored procedures are utilized by the volume dataset manager service 1004d running in the application server (e.g., the XS engine 120). This service provides functionality to import/export datasets (e.g., scanner data—such as CT, MM, etc.) into the system. The volume dataset manager service 1004d exposes its functionality using a REST-API. This API can be used by a dedicated dataset management UI (e.g., web-based UI, mobile UI, etc.). Due to the fact that it is an open API, it could also be used by 3rd-party providers who would like to directly integrate scanner technology into the system. The volume dataset manager service 1004d is also used inside electronic medical records to access the volume data related to a particular patient (along with rendering services using the volume dataset manager service 1004d to access volume data stored in the persistence layer).

The collaboration manager service 1004e is a wrapper service, which wraps functionality of a connected collaboration platform (e.g. the collaboration application 1006 and associated collaboration API 1008 and collaboration data 1010) and exposes a subset of the collaboration functionality in the context of the described services. The collaboration application 1006 supports a collaboration platform to allow domain experts (e.g., medical personnel) to engage in patient-related discussions in the context of corresponding electronic patient data. The collaboration API 1008 typically offers functionality similar to:
Group manipulation
   Create groups, read groups, update groups and delete groups, and
   Copy groups,
Group membership
   Manipulate group membership (by adding or removing members), group admin data, or the group picture,
Group content
   Create, read, update, and delete group content like wikis and blogs,
   Create, read, update, and delete forums, questions, discussions, and ideas, and
   Add or feature complex business objects to a group,
Get notifications and accept or dismiss them, and
Search.
   Collaboration related data is stored in the collaboration data 1010 persistence of the connected collaboration platform. This data can be accessed using the collaboration API 1008. Typical collaboration data includes group information (e.g., groups of individuals who collaborate on a particular topic), group content (wikis, forums, chats), collaboration participant contact information, computing system information for various remote rendering systems, collaborative permissions, team data, and other data consistent with this disclosure.

For example, the collaboration manager service allows a user to generate an invitation to a remote colleague(s) to join an interactive session viewing images rendered by the remote rendering service. Although the collaboration application 1006 is illustrated as separate from the in-memory database platform 106, in other implementations, the collaboration application 1006 (and/or associated collaboration API 1008 and collaboration data 1010 can be integrated into one or other components of the system illustrated in FIG. 10). Typically, the collaboration API 1008 is used to provide access, data, etc. to/from the collaboration application. Note that the collaboration manager service 1004e is also responsible, in some implementations, for providing “historic” collaboration data in the context of an electronic medical record. For example, during an interactive collaboration session, a chat (e.g., text messages) can be persisted in the collaboration application 1006/collaboration data 1010 using the collaboration manager service 1004e. This chat can be linked to the electronic medical record. When accessing the electronic medical record at a later point in time, the created “historical” chat can be retrieved from the connected collaboration application 1006 using the collaboration manager service 1004e and the collaboration API 1008 and displayed at the corresponding position inside the medical record (e.g., if there was a chat regarding a particular CT-scan).

In some implementations, the enterprise collaboration application 1006 can support session recording. In some implementations, one or more session recording functions (e.g., start, stop, pause, save, delete, naming, etc.) can be automatically performed by the described system. In other implementations, one or more session recording functions can also be exposed through the collaboration manager service for collaboration participant initiation/termination. For example, the collaboration manager service 1004e can initiate display of a collaboration user interface providing the described and other functionality consistent with this disclosure. The collaboration user interface can be viewed and interacted with by one or more of collaboration participants. In typical implementations, recorded session content can be persisted by the collaboration system in the in-memory database system 204. In some instances, a corresponding session identification can be stored in context of a particular patient's record (e.g., as a link to the actual recording which is stored by the connected collaboration manager service 1004e). The collaboration manager service can also limit functions available to one or more collaboration participants (e.g., the initiator may be the only participant that can use recording functionality, etc.). Collaboration access privileges can be persisted in an access privileges 1012 persistence and/or in another persistence(s), service(s), etc. (whether or not displayed). Access privileges 1012 for bookmarks and annotations can be managed using access control lists (ACL). An ACL is basically a list of permissions attached to a bookmark or an annotation. An ACL specifies which users are granted access to objects, as well as what operations are allowed on given objects. Each entry in a typical ACL specifies a subject and an operation.

In typical implementations during collaboration sessions, collaboration participants can (e.g., based on particular privileges associated with a collaboration participant—such as an administrator, viewer only, annotator, etc.) create bookmarks and annotations or modify existing bookmarks and annotations (e.g., create new versions) and share them with other collaboration participants. In typical implementations, the created/versioned bookmarks and annotations can be persisted in the bookmark data 1014 and annotation data 1016 persistencies, respectively. In other implementations, the created/versioned bookmarks and annotations can be persisted in additional and/or alternative components of the system of FIG. 1 (e.g., collaboration data 1010, tables of the in-memory database 204, etc.—whether or not illustrated). The collaboration manager service 1004e can also allow sharing of bookmarks and related annotations between collaboration participants (e.g. sending bookmark encoded as URL in a GUI chat-type session between collaboration participants).

The annotation manager service 1004f typically provides functionality to define, store, and retrieve information related to annotations associated with datasets (e.g. voxel data). An annotation can be of various type (e.g., text, links to documents, marking of regions of interest, etc.) in a rendered volume dataset and can be related to one or several bookmarks. The annotations manager service 1004f can also verify that corresponding bookmarks do exist for annotations requested to be stored (e.g., using the bookmark management 1020 and/or annotation matching 1022 stored procedures). In some implementations, the annotation manager service 1004f can generate a unique identifier for a new annotation and store the annotation in an annotation persistence. The service also supports all CRUD operations (e.g., create, read, update and delete bookmarks) using the corresponding REST-API. The annotation service also keeps track of access privileges for annotations. The REST-API provides mechanisms to define groups of users with different access privileges (e.g., read, modify, delete) who have access to the annotation and can perform the provided operations. Similar to the description of the collaboration manager service 1004e and associated UI, the annotation manager service 1004f can also generate an annotation GUI to, for example, perform the above-described CRUD operations related to annotations.

In typical implementations, the bookmark manager service 1004g provides functionality to define, store, and retrieve information related to bookmarks for volume datasets 208 (e.g. voxel data). A bookmark is described by a particular viewing position (e.g., 3D coordinates), a viewing angle (e.g., direction-of-view), and a zoom factor, all in the context of a current dataset. The bookmark manager service 1004g can generate a unique identifier for a new bookmark and stores the bookmark in the bookmark data 1014 persistence. The bookmark manager service 1004g can also support all CRUD operations (e.g., create, read, update, and delete for bookmarks) using a corresponding REST-API. Similar to the description of the collaboration manager service 1004e and associated UI, the bookmark manager service 1004g can also generate a bookmark GUI to, for example, perform the above-described CRUD operations related to bookmarks. The bookmark manager service 1004f can also keep track of access privileges for single bookmarks (e.g., using the bookmark management 1020 stored procedure). An associated REST-API can also provide mechanisms to define groups of users with different access privileges (e.g., read, modify, and/or delete) who have access to a particular bookmark and can perform associated permitted operations.

Apart from annotation and volume data stored in the in-memory database management system 204 (e.g., volume datasets 208 and annotation data 1016), flexible query-mechanisms of the in-memory database management system 204 support linking of annotation data and volume data produce by 3D scanners. This allows automatic linking of generated annotations to particular visualizations from arbitrary viewing positions and showing the corresponding annotated region of interest to a viewer.

Annotation data 1016 is typically stored in the in-memory database 204 as a particular table. Typically, the following data can be stored for each annotation:
Unique annotation id,
List of related bookmarks,
Annotation type identifier (e.g., text, link to document, image marker information),
Link to annotation content (e.g., annotation content is stored in a corresponding persistence based on the annotation type), and
Authorization information.

Bookmark data 1014 is typically stores in the in-memory database 204 as a particular table. Rather than storing multiple copies of created image data, “bookmarks” in the voxel data are created and stored. These bookmarks are encoded parameters for the remote rendering system (i.e., coordinates in the 3D model with perspective virtual camera information) which allow annotation of a region in the scan (e.g., a tumor). The bookmarks can be freely defined and shared with colleagues who have access to the certain electronic patient record. Based on the encoded rendering parameters a visualization is re-created on the fly. This dramatically reduces the amount of data stored in an electronic medical patient record. Typically, the following data can be stored for each bookmark:
Unique bookmark id,
Metadata
   Scan ID (e.g., persisted scanner data—voxel model),
   Viewing position (e.g., x/y/z coordinates in voxel 3D space),
   Viewing direction,
   Zoom factor, and
   Authorization information (e.g., ID of an ACL).

Additional stored procedures 122 include dataset management 1018, bookmark management 1020, and annotation matching 1022. Dataset management 1018 is typically realized as a set of one or more stored procedures which provide fast access to stored volume datasets 208 (e.g., voxel models produced by a CT scan) using a volume directory 206. The dataset management 1018 stored procedures are typically utilized by the volume dataset manager service 1004d. In a typical implementation, the bookmark management stored procedure is a SQL-script which calls a sub-program implemented in the L-programing language (a specific container of the SAP HANA in-memory database). The L-Programming language allows implementation of complex application logic inside the database layer which is callable using SQL-script. Therefore, basic JOIN-logic for accessing bookmarks, annotations, and authorization data related to certain regions of interest inside a volume dataset is implemented in the L programming language and deployable to the in-memory database system. Other implementations are considered within the scope of this disclosure. Annotation matching 1022 is typically realized as a set of stored procedures which can perform a fast lookup operations of matching between annotations and bookmarks. The annotation matching 1022 stored procedures also take into account defined ACLs for bookmarks and annotations. The stored procedures are typically utilized by the annotation manager service 1004f.

Domain experts (e.g. medical experts) can interact with the described visualization system to, among other things, change viewing positions related to volume data of interest. During a diagnosis process, data can be collaboratively accessed and viewed and a focus of visualizations can be modified and refined if needed (e.g., by adding one or more annotations). Thus, medical experts can discuss and interact with the volume data (e.g., creating new visualizations from arbitrary viewing angles while exploring a volume dataset interactively) as well as adding annotations to the dataset, where those annotations are immediately visible to all participants of the discussion at the corresponding viewing positions in the 3D dataset). The medical experts can also bookmark particular viewpoints related to the volume dataset that have been annotated. All communication can be recorded by the above-described collaboration functionality for later analysis (e.g., historical purposes, review of the collaborative session) or for domain experts (e.g., those who could not participate in the collaborative session) which are pulled into the diagnosis process at a later point in time. Discussions can be performed in the context of the patient data while annotations are maintained and persisted together with all patient data in the in-memory database management system 204. When a particular visualization is requested again, added annotations related to the volume dataset 208 data can be automatically recovered from the annotation data 1016 and rendered for viewing or rendered but kept invisible until requested. In some implementations, the annotations may not be rendered/visible unless the particular visualization is viewed from a particular viewing position (or within some type of threshold value of a particular viewing position, etc.) where the annotation originally was made. In other implementations, one or more annotations associated with a particular visualization will be displayed/filtered depending upon, for example, viewer permissions, filter settings (e.g., who generated the annotation, how new/old is the annotation, importance values associated with a particular annotation, relevance factors to the patient, medical treatment needed, and other filter settings).

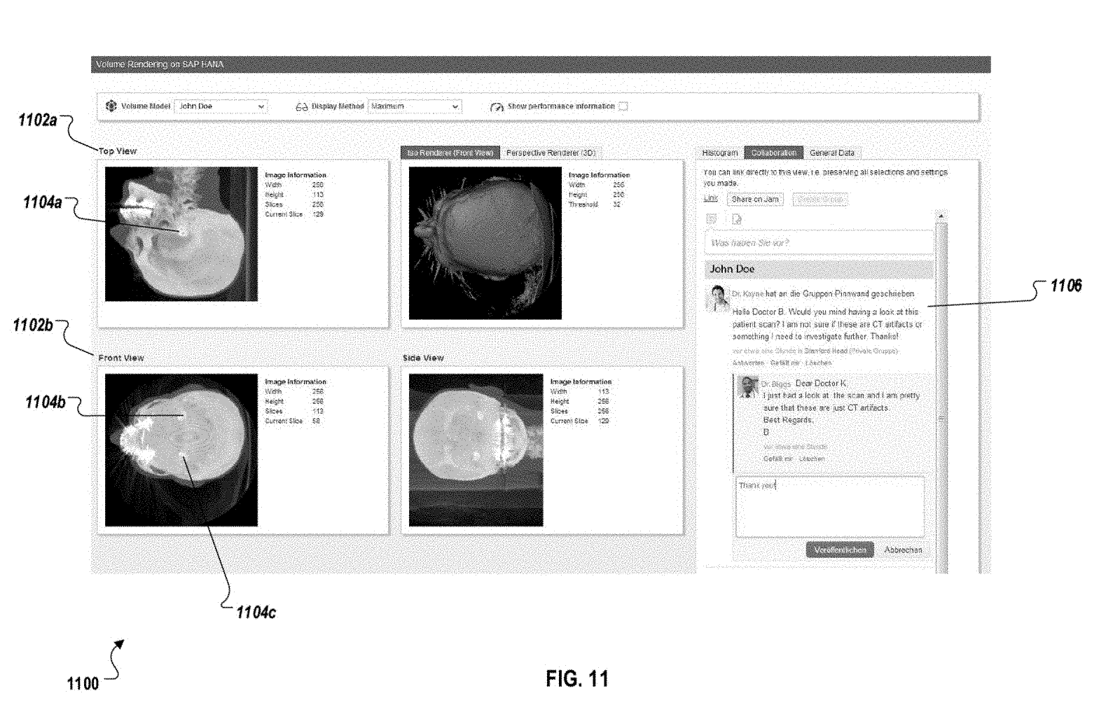

FIG. 11 is an example screenshot 1100 of an example GUI where a modification of a viewing angle and regions of interest associated with a 3D volume dataset are taking place while discussing visualized artifacts, according to an implementation. As can be seen, for example, the example GUI provides, among others, a top view 1102a and bottom view 1102b viewing angle. Regions of interest (e.g., 1104a, 1104b, and 1104c) can also be indicated through the illustrated UI. In addition, a textual chat-type collaboration session can also be participated in to permit interactive discussion of the visualized scanned dataset.

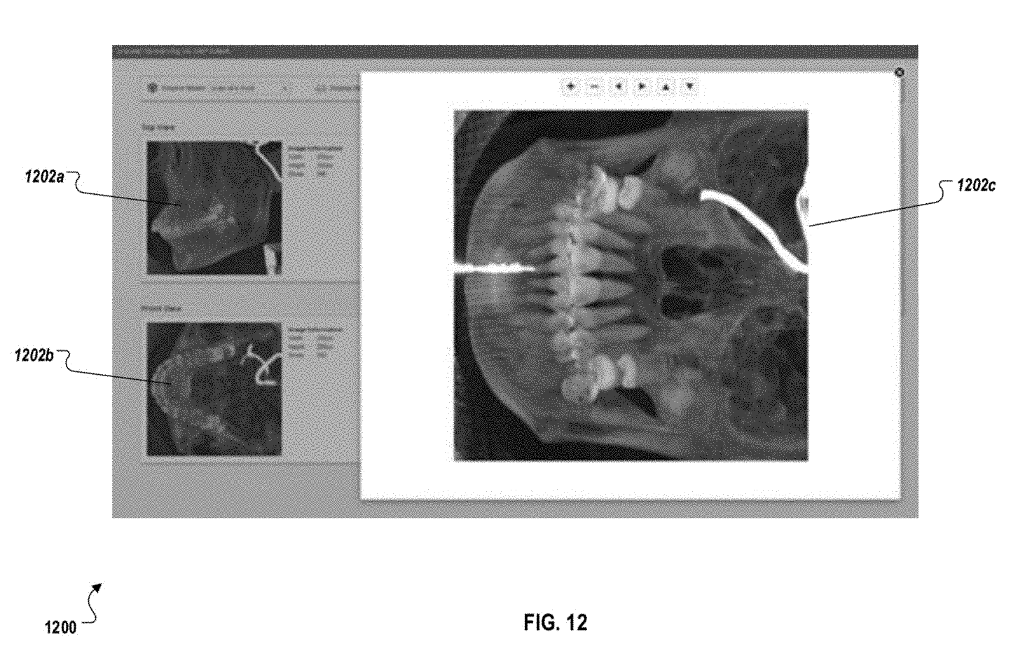

FIG. 12 is an example screenshot 1200 of a visualization of an electronic medical record on a client computing device following rendering computations performed on a remote server-based rendering system providing open APIs, according to an implementation. The screenshot illustrates 3D scanner data from various viewing angles (e.g., viewing angles 1202a and 1202b) and a zoomed viewing angle 1202c. Visualizations are performed by executing heavy computations on a server-side computing system that provides visualization data for mobile or other device use (e.g., using a mobile software development kit to access a centrally-implemented GUI—for example on the server-side computing system).

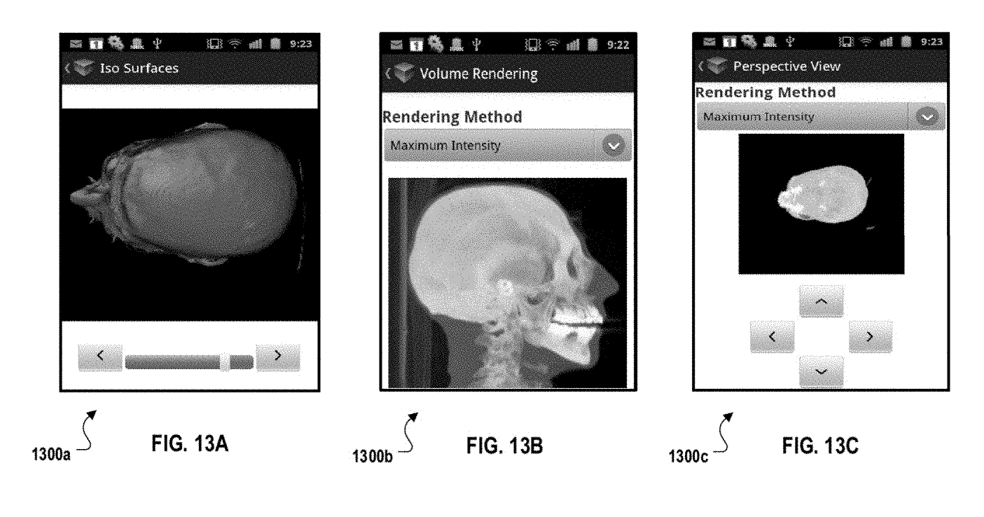

FIGS. 13A-13C are screenshots 1300a-1300c of a native implementation of a mobile-device user interface (UI) displaying electronic medical records through an open API provided by a remote server-based rendering system, according to an implementation. In a typical implementation, the remote rendering system provides open APIs allowing the described functionality to be integrated into native mobile device applications. For example, FIG. 13A illustrates a native implementation of an ANDROID-based GUI displaying an ISO Surface rendering of a 3D volume dataset. FIG. 13B illustrates a native implementation of an ANDROID-based GUI displaying a Volume Rendering of a 3D volume dataset using a Maximum Intensity Rendering method. FIG. 13C illustrates a native implementation of an ANDROID-based GUI displaying Perspective View of a 3D volume dataset using a Maximum Intensity Rendering method.

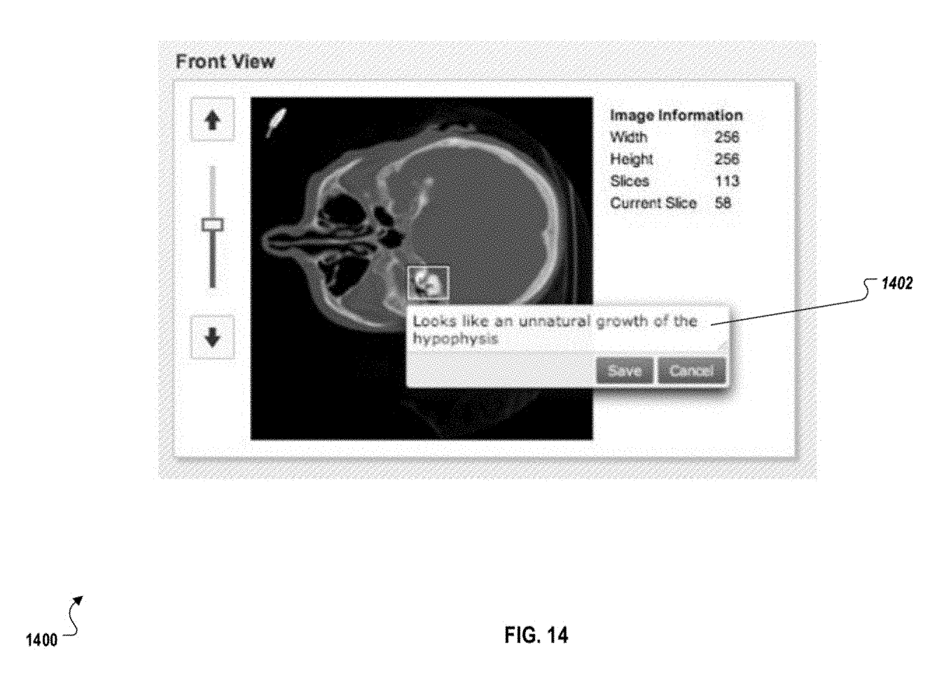

FIG. 14 is a screenshot 1400 of a generated textual annotation associated with a region of interest within a visualized medical image, according to an implementation. For example, textual annotation 1402 has been associated with a region-of-interest in a volume dataset (e.g., here a scan of a skull) and states “Looks like an unnatural growth of the hypothesis.” This textual annotation 1402 adds information and knowledge to the volume dataset rather than to particular images in a standard clinical environment and allows validation and qualification of imaging biomarkers in response to therapy and prognosis that could be used in clinical practice. Multiple medical experts can view, analyze, and/or discuss regions of interest in medical images remotely regardless of location and time. Collaborative sessions can be used to analyze, annotate regions of interest within medical images, and ultimately help facilitate effective knowledge transfer and allow medical specialists to be reached at any time. Created annotations not only include textual annotations, but can also graphical annotations, clinical diagnostic information, voice/audio data, image content feature information (e.g. interactively highlighting/coloring interesting regions), and/or other forms of annotations consistent with this disclosure.

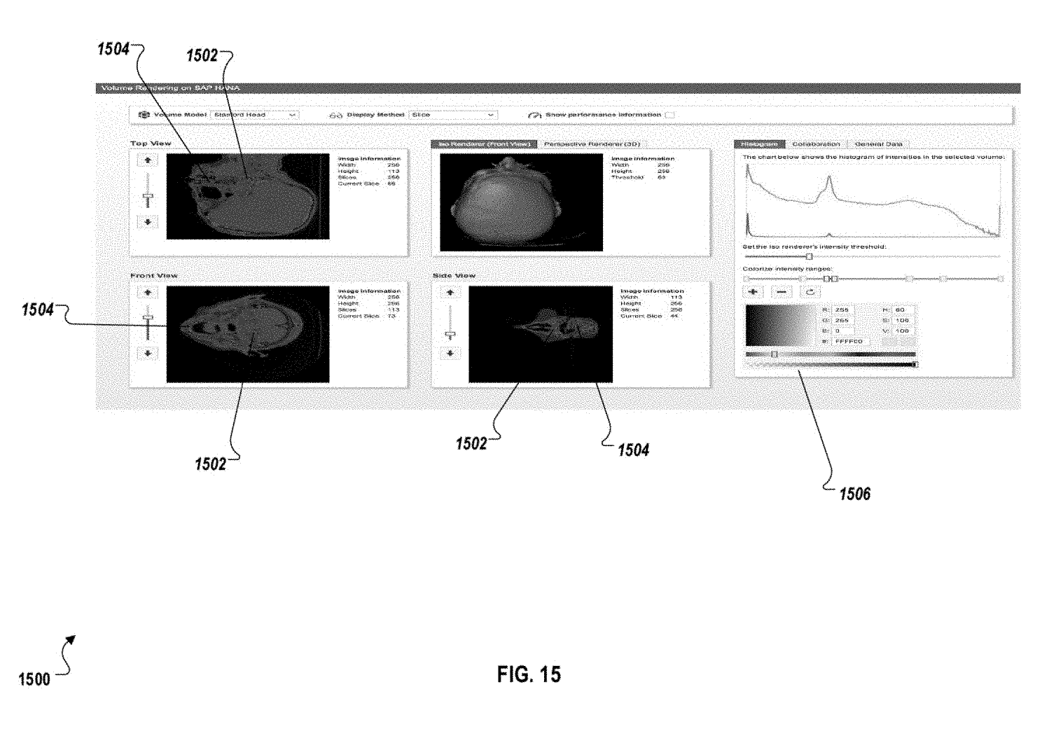

FIG. 15 is a screenshot 1500 of interactive colorization of regions of interest in a 3D volume dataset, according to an implementation. For example, as shown in FIG. 15, colorizations 1502, 1504, and 1506 can be reflected in various viewing angles of a volume dataset. Also illustrated are an example set of colorization controls 1506 for highlighting/coloring.

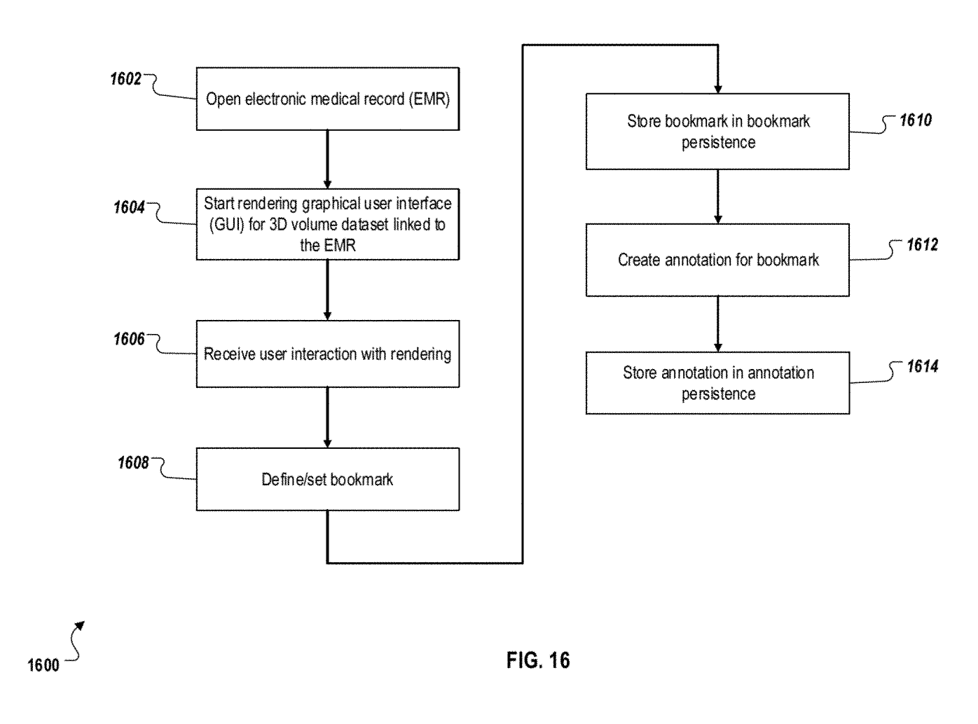

FIG. 16 is a flow chart of a method 1600 for setting a bookmark in a volume dataset associated with an electronic medical record, according to an implementation. For clarity of presentation, the description that follows generally describes method 1600 in the context of FIGS. 1-8, 9A & 9B, 10-12, 13A-13C, 14-15, and 17-18. However, it will be understood that method 1600 can be performed, for example, by any suitable system, environment, software, and hardware, or a combination of systems, environments, software, and hardware as appropriate. In some implementations, various steps of method 1600 can be run in parallel, in combination, in loops, and/or in any order.

At 1602, an electronic medical record is accessed from a storage location (e.g., the electronic medical record of FIG. 2) and opened, for example by a medical expert using a provided GUI on a mobile or other device. From 1602, method 1600 proceeds to 1604.

At 1604, a 2D rendering of a 3D volume dataset associated with the electronic medical record is generated in the GUI on the mobile or other device. Note that an electronic medical record is not limited to a single 3D volume dataset (scan). Usually, over time, many different scans can be performed for a particular patient and all available scans (volume data) can be linked to the electronic medical record. As such, new 2D images can be generated for “old” scans from different viewing positions—particularly interesting/useful if historical data has to be compared with current data. Whereas in existing solutions only static 2D images are linked to a medical record, the described functionality provides a way to immediately generate new images for desired viewing positions. From 1604, method 1600 proceeds to 1606.

At 1606, the medical expert can interact with the rendering of the 3D volume dataset. For example, interactions can include, among other possible interactions, moving a viewing position, modifying a viewing direction, rotating a model, and zooming into/out of a model. From 1606, method 1600 proceeds to 1608.

At 1608, the medical expert can define a bookmark associated with the rendering using the GUI. Defining a bookmark can, in some implementations include linking bookmark metadata to current rendering parameters (e.g., position, viewing angle, etc.) and defining groups of users with different access privileges (e.g., read, write, modify, and delete) who have access to the defined bookmark and can perform operations associated with the bookmark. In typical implementations, bookmarks are stored in separate tables in the in-memory database. Typically, there is a direct relationship between an annotation and a bookmark—an annotation is always related to at least one bookmark and there can be several annotations referring to one bookmark). This relationship is expressed by foreign-key relationships. Thus, for an annotation, the corresponding identifiers for related bookmarks are persisted. This can be achieved by introducing a dedicated mapping table (e.g., a lookup index) which stores a mapping of an annotation-id to a bookmark-id. The focus here is on lookup-performance as the described system operates quickly to identify annotations related to a bookmark in order to provide visual feedback with low latency in the electronic medical record when a bookmark is opened. From 1608, method 1600 proceeds to 1610.

At 1610, the defined bookmark can be stored in a bookmark persistence. From 1610, method 1600 proceeds to 1612.

At 1612, the medical expert can create one or more annotations for the defined bookmark. In some implementations, the one or more annotations can be created and related to one or several bookmarks, annotations of various types can be supported (e.g., text, links to documents, marked regions-of-interest, etc.), and/or groups of users can be defined with different access privileges (e.g., read, write, modify, and delete) who have access to the one or more annotations and can perform operations associated with the one or more annotations. From 1612, method 1600 proceeds to 1614.

At 1614, the one or more annotations are stored in an annotation persistence. After 1614, method 1600 stops.

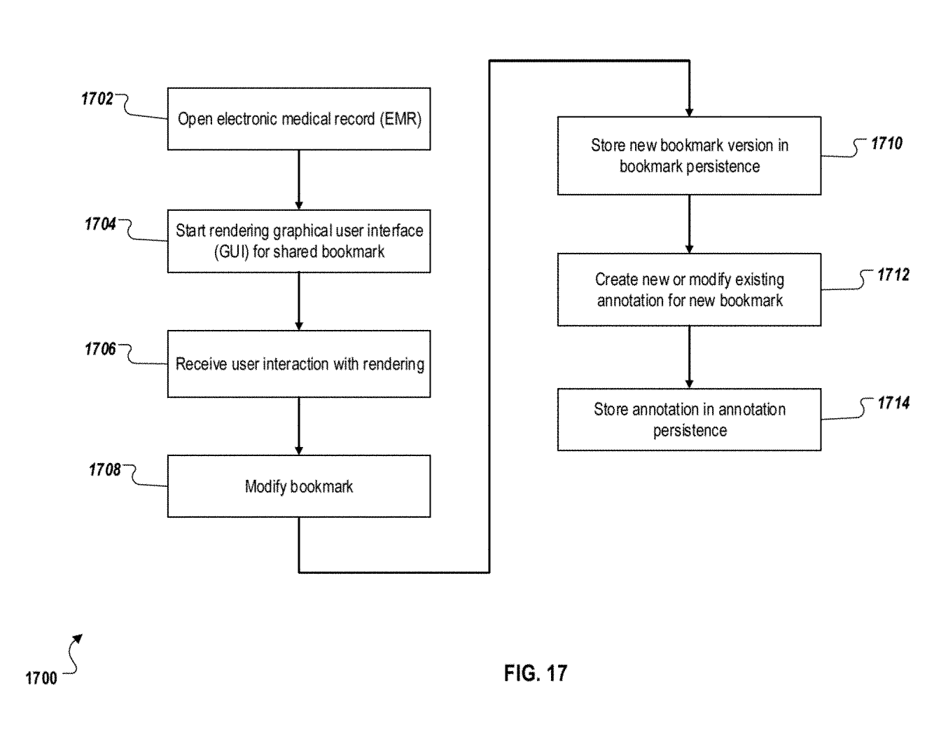

FIG. 17 is a flow chart of a method 1700 for modifying a bookmark in a volume dataset associated with an electronic medical record, according to an implementation. For clarity of presentation, the description that follows generally describes method 1700 in the context of FIGS. 1-8, 9A & 9B, 10-12, 13A-13C, 14-16, and 18. However, it will be understood that method 1700 can be performed, for example, by any suitable system, environment, software, and hardware, or a combination of systems, environments, software, and hardware as appropriate. In some implementations, various steps of method 1700 can be run in parallel, in combination, in loops, and/or in any order.

At 1702, an electronic medical record is accessed from a storage location (e.g., the electronic medical record of FIG. 2) and opened, for example by a medical expert using a provided GUI on a mobile or other device. From 1702, method 1700 proceeds to 1704.

At 1704, a 2D rendering of a 3D volume dataset associated with the electronic medical record as identified by a shared bookmark is generated in the GUI on the mobile or other device. In typical implementations, when the electronic medical record is generated using a shared bookmark:
Access rights are checked (e.g., is the collaborative user allowed to open the bookmark and related annotations?),
The visualization is created based on the defined rendering parameters of the bookmark, and
Linked annotations are retrieved from the annotation persistence. Access privileges are checked during retrieval.
   Note that, in the case where a bookmark is not shared (e.g., created by a medical expert for private review), functions consistent with the above and with this disclosure, but not related to a collaboration, can be performed. From 1704, method 1700 proceeds to 1706.

At 1706, the medical expert can interact with the rendering of the 3D volume dataset. For example, interactions can include, among other possible interactions, moving a viewing position, modifying a viewing direction, rotating a model, and zooming into/out of a model. From 1706, method 1700 proceeds to 1708.

At 1708, the medical expert can modify a defined a bookmark associated with the rendering using the GUI. Modifying a defined bookmark can, in some implementations include:
If the user has acceptable privileges, a new bookmark version with modified rendering parameters is created. The system maintains a bookmark history so that prior bookmark versions may also be accessed,
Linking bookmark metadata to current rending parameters (e.g., position, viewing angle, etc.), and
Defining groups of users with different access privileges (e.g., Read, Modify, and

Delete) who have access to the bookmark and can perform the configured operations.

From 1708, method 1700 proceeds to 1710.

At 1710, the modified bookmark can be stored in a bookmark persistence. From 1710, method 1700 proceeds to 1712.

At 1712, the medical expert can create or modify one or more annotations for the defined bookmark. In some implementations, the one or more created/modified annotations can be related to one or several bookmarks, the one or more created/modified annotations of various types can be supported (e.g., text, links to documents, marked regions-of-interest, etc.), and/or groups of users can be defined with different access privileges (e.g., read, write, modify, and delete) who have access to the one or more annotations and can perform operations associated with the one or more annotations. From 1712, method 1700 proceeds to 1714.

At 1714, the one or more annotations are stored in an annotation persistence. After 1714, method 1700 stops.

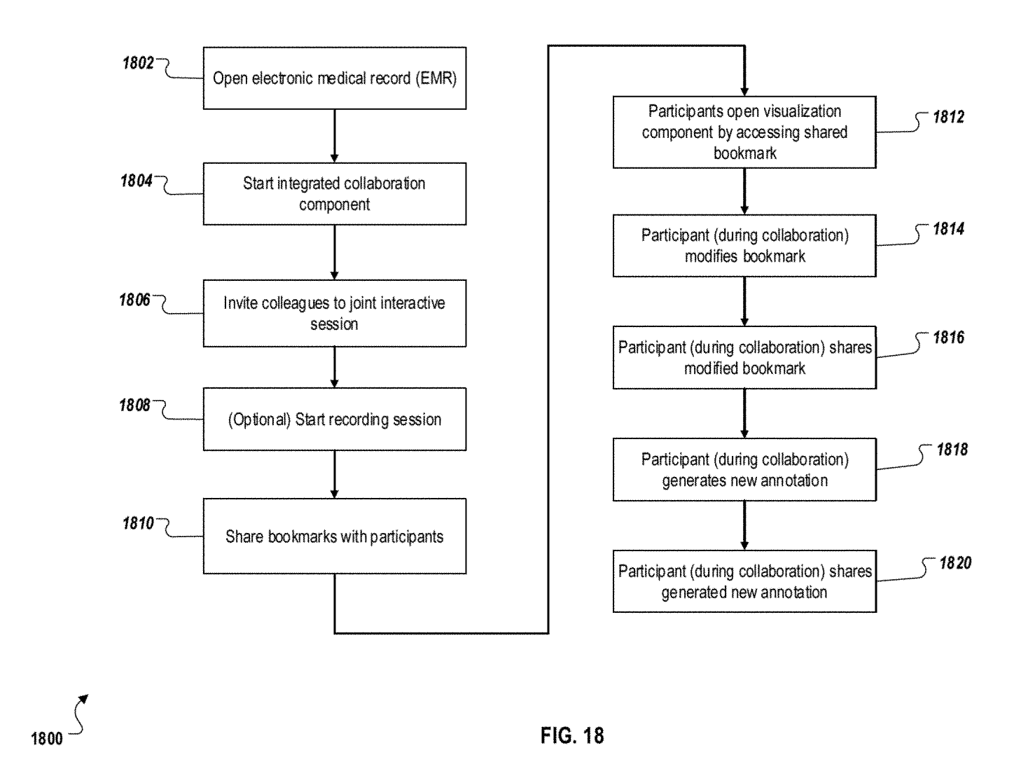

FIG. 18 is a flow chart of a method 1800 for collaboration with a volume dataset associated with an electronic medical record, according to an implementation. For clarity of presentation, the description that follows generally describes method 1800 in the context of FIGS. 1-8, 9A & 9B, 10-12, 13A-13C, and 14-17. However, it will be understood that method 1800 can be performed, for example, by any suitable system, environment, software, and hardware, or a combination of systems, environments, software, and hardware as appropriate. In some implementations, various steps of method 1800 can be run in parallel, in combination, in loops, and/or in any order.

At 1802, an electronic medical record is accessed from a storage location (e.g., the electronic medical record of FIG. 2) and opened, for example by a medical expert using a provided GUI on a mobile or other device. From 1802, method 1800 proceeds to 1804.

At 1804, the collaboration component is started (e.g., using a plugin implemented based on the collaboration API). In some implementations, the GUI can be used to trigger a collaboration session using the integrated collaboration component. From 1804, method 1800 proceeds to 1806.

At 1806, the medical expert can invite one or more colleagues to join an interactive session. From 1806, method 1800 optionally proceeds to 1808 or proceeds to 1810.

At optional 1808, a recording of the collaborative session is started. In this case, the session content is persisted and the corresponding session ID is stored in the context of the electronic medical record. From 1808, method 1800 proceeds to 1810.

At 1810, one or more defined bookmarks can be shared with collaboration participants. For example, a bookmark can be encoded as a uniform resource locator (URL), possibly in a chat session. As one of many possible alternatives understood by those of ordinary skill in the art, the sharing of bookmarks could also be achieved using a publish/subscribe mechanism where an event is published as soon as a bookmark is created/updated and all subscribed bookmark visualization components can perform an UI refresh as soon as they receive the notification. From 1810, method 1800 proceeds to 1812.

At 1812, collaboration participants can open a visualization associated with the one or more defined bookmarks (e.g., clicking on a shared URL) with the visualization component. The corresponding visualization is generated on-the-fly and the related annotations are retrieved and displayed. From 1812, method 1800 proceeds to 1814.

At 1814, during the collaboration session, the collaboration participants can, based on their privileges, modify the bookmarks (or create new versions) and share them with the other collaboration participants. From 1814, method 1800 proceeds to 1816.

At 1816, a collaboration participant can share a modified bookmark. From 1816, method 1800 proceeds to 1818.

At 1818, a collaboration participant can create one or more annotations for the modified bookmark.

In some implementations, the one or more created/modified annotations can be related to one or several bookmarks, the one or more created/modified annotations of various types can be supported (e.g., text, links to documents, marked regions-of-interest, etc.), and/or groups of users can be defined with different access privileges (e.g., read, write, modify, and delete) who have access to the one or more annotations and can perform operations associated with the one or more annotations. The one or more annotations are stored in an annotation persistence. From 1818, method 1800 proceeds to 1820.

At 1820, the one or more annotations can be shared during the collaboration session. In typical implementations, as soon as an annotation is persisted it is assigned a unique identifier. This unique identifier can be used to access the corresponding annotation information. For actual sharing functionality, there are various available options. One possible solution is a URL which can be shared between the participants of a collaboration session (e.g., in a chat). Another possible solution is a special visualization component for annotations (e.g., a simple list) which operates in a publish/subscribe mode. This means that as soon as a new annotation is stored a corresponding event can be published and all UI components (e.g., annotation lists) which have subscribed to that type of event can update the list content accordingly. After 1820, method 1800 stops.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other GUI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
opening an accessed electronic medical record (EMR) on a mobile computing device;
receiving, in a graphical user interface (GUI) on the mobile device, a rendered visualization of a three-dimensional (3D) volume dataset associated with the EMR;
interacting with the visualization using the GUI;
defining a bookmark associated with the rendered visualization; and
defining an annotation associated with the rendered visualization and the defined bookmark.

2. The method of claim 1, wherein the interactions include one or more of moving a viewing position, modifying a viewing direction, rotating a model, and zooming of a model.

3. The method of claim 1, wherein the defined bookmark is stored in a bookmark persistence, the defined annotation is stored in an annotation persistence, and wherein defining the bookmark comprises:
linking bookmark metadata to current rendering parameters; and
defining groups of users with different access privileges who have access to the defined bookmark and can perform operations associated with the bookmark.

4. The method of claim 1, comprising:
modifying the defined bookmark, wherein modifying the defined bookmark comprises:
generating a new bookmark version with modified rendering parameters;
linking the new bookmark version metadata to current rending parameters; and
defining access privileges to the new bookmark version for different users; and
storing the modified bookmark into the bookmark persistence.

5. The method of claim 5, comprising opening the rendering of the 3D volume dataset using the defined bookmark, the opening of the rendering of the 3D volume dataset comprises:
checking access rights to open the bookmark;
generating a visualization based on the rendering parameters associated with the bookmark; and
retrieving annotations linked to the bookmark.

6. The method of claim 1, comprising, following the opening of the EMR, starting a collaboration session associated with the 3D volume dataset of the EMR using a collaboration component and inviting other users to join the collaboration session.

7. The method of claim 6, comprising recording the collaborative session and persisting session content using an associated session identification corresponding to the EMR.

8. The method of claim 6, comprising:
receiving a modified or new version of a bookmark;
sharing the modified or new version of the bookmark with other collaboration session users; and
creating one or more annotations associated with the modified or new version of the bookmark.

9. The method of claim 6, comprising sharing a previously-defined bookmark with a different user of the collaboration session.

10. The method of claim 8, wherein the rendered visualization is associated with the shared, different, previously-defined bookmark.

11. A non-transitory, computer-readable medium storing one or more computer-readable instructions executable by a hardware processor and configured to:
open an accessed electronic medical record (EMR) on a mobile computing device;
receive, in a graphical user interface (GUI) on the mobile device, a rendered visualization of a three-dimensional (3D) volume dataset associated with the EMR;
interact with the visualization using the GUI;
define a bookmark associated with the rendered visualization; and
define an annotation associated with the rendered visualization and the defined bookmark.

12. The non-transitory, computer-readable medium of claim 11, wherein the defined bookmark is stored in a bookmark persistence, the defined annotation is stored in an annotation persistence, and wherein defining the bookmark comprises one or more computer-readable instructions to:
link bookmark metadata to current rendering parameters; and
define groups of users with different access privileges who have access to the defined bookmark and can perform operations associated with the bookmark.

13. The non-transitory, computer-readable medium of claim 11, comprising one or more computer-readable instructions to:
modify the defined bookmark, wherein modifying the defined bookmark comprises one or more computer-readable instructions to:
generate a new bookmark version with modified rendering parameters;
link the new bookmark version metadata to current rending parameters; and
define access privileges to the new bookmark version for different users; and
store the modified bookmark into the bookmark persistence.

14. The non-transitory, computer-readable medium of claim 11, comprising, following the opening of the EMR, one or more computer-readable instructions to start a collaboration session associated with the 3D volume dataset of the EMR using a collaboration component and inviting other users to join the collaboration session.

15. The non-transitory, computer-readable medium of claim 14, comprising one or more computer-readable instructions to record the collaborative session and to persist session content using an associated session identification corresponding to the EMR.

16. A computer-implemented system, comprising:
a hardware processor interoperably coupled with a computer memory and configured to:
open an accessed electronic medical record (EMR) on a mobile computing device;
receive, in a graphical user interface (GUI) on the mobile device, a rendered visualization of a three-dimensional (3D) volume dataset associated with the ERM;
interact with the visualization using the GUI;
define a bookmark associated with the rendered visualization; and
define an annotation associated with the rendered visualization and the defined bookmark.

17. The computer-implemented system of claim 16, wherein the defined bookmark is stored in a bookmark persistence, the defined annotation is stored in an annotation persistence, and wherein defining the bookmark comprises:
linking bookmark metadata to current rendering parameters; and
defining groups of users with different access privileges who have access to the defined bookmark and can perform operations associated with the bookmark.

18. The computer-implemented system of claim 16, configured to:
modify the defined bookmark, wherein modifying the defined bookmark comprises:
generating a new bookmark version with modified rendering parameters;
linking the new bookmark version metadata to current rending parameters; and
defining access privileges to the new bookmark version for different users; and
store the modified bookmark into the bookmark persistence.

19. The computer-implemented system of claim 16, configured, following the opening of the EMR, to start a collaboration session associated with the 3D volume dataset of the EMR using a collaboration component and to invite other users to join the collaboration session.

20. The computer-implemented system of claim 16, configured to record the collaborative session and to persist session content using an associated session identification corresponding to the EMR.
